(19) United States
(12) Patent Application Publication
(10) Pub. No.: US 2025/0133468 A1
(43) Pub. Date: Apr. 24, 2025

(54) METHOD AND APPARATUS FOR MOBILITY ENHANCEMENT IN A WIRELESS COMMUNICATION SYSTEM

(71) Applicant: Samsung Electronics Co., Ltd., Gyeonggi-do (KR)

(72) Inventors: Fuyuan LI, Beijing (CN); Bin WANG, Beijing (CN); Hong WANG, Beijing (CN); Lixiang XU, Beijing (CN); Weiwei WANG, Beijing (CN); Donmyoung LEE, Gyeonggi-do (KR)

(21) Appl. No.: 18/834,352

(22) PCT Filed: Jan. 30, 2023
(86) PCT No.: PCT/KR2023/001364

§ 371 Date: Jul. 30, 2024

(30) Foreign Application Priority Data
Jan. 30, 2022 (CN) 202210113651.6

(51) Int. Cl. H04W 36/36; H04W 36/00; H04W 76/20

(52) U.S. Cl. CPC H04W 36/362; H04W 36/00835; H04W 76/20

(57) ABSTRACT

The disclosure relates to a 5G or 6G communication system for supporting a higher data transmission rate. The present disclosure provides a method performed by a user equipment (UE) in a wireless communication system. The method includes: receiving a message including a first indication, wherein the first indication is used to indicate keeping resources of candidate cells; and determining a target cell from the candidate cells and performing cell access.

### TECHNICAL FIELD

The application relates to wireless communication technology, in particular, to a mobility enhancement and optimization mechanism when a user equipment (UE) is in the case of mobility, so as to reduce the service interruption delay to the UE in the serving cell change procedure, and to reduce the signalling overhead between network nodes and with the UE.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”

Wireless communication is one of the most successful innovations in modern history. Recently, a number of subscribers of wireless communication services has exceeded 5 billion, and it continues growing rapidly. With the increasing popularity of smart phones and other mobile data devices (for example, tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Solution to Problem

According to some embodiments of the present disclosure, a method performed by a user equipment (UE) in a wireless communication system is provided. The method includes: receiving a message including a first indication, wherein the first indication is used to indicate keeping resources of candidate cells; and determining a target cell from the candidate cells and performing cell access.

For example, in some embodiments, the first indication is further used to indicate releasing resources of the candidate cells that the UE has accessed once.

For example, in some embodiments, the method further includes releasing resource of a source cell.

For example, in some embodiments, after releasing the resource of the source cell, the method further includes: receiving a message including a resource configuration information of the source cell and receiving a message including a second indication; wherein the second indication is used to indicate keeping the resource of the source cell until the source cell is selected as a target cell for cell access; and wherein the message including the resource configuration information of the source cell and the message including the second indication are the same message or different messages.

For example, in some embodiments, after performing the cell access, the method further includes: releasing the resource of the source cell; receiving the message including the resource configuration information of the source cell; and receiving a message including a third indication, wherein the third indication is used to indicate keeping the resource of the source cell; and wherein the message including the resource configuration information of the source cell and the message including the third indication are the same message or different messages.

For example, in some embodiments, the message further includes a third indication, and the third indication is used to indicate keeping the resource of the source cell.

For example, in some embodiments, the message is a radio resource control (RRC) reconfiguration message.

According to some embodiments of the present disclosure, a method performed by a first network node in a wireless communication system is provided. The method includes: transmitting, to other network nodes and/or a user equipment (UE), a message including a first indication, wherein the first indication is used to indicate keeping resource of candidate cells.

For example, in some embodiments, the first indication is further used to indicate releasing resources of the candidate cells that the UE has accessed once.

For example, in some embodiments, the method further includes releasing resource of a source cell after the UE accessing a target cell.

For example, in some embodiments, after releasing the resource of the source cell, the method further includes: transmitting, to other network nodes and/or the UE, a message including a second indication, wherein the second indication is used to indicate keeping the resource of the source cell until the source cell is selected as a target cell for cell access.

For example, in some embodiments, the method further includes: releasing resource of a source cell after the UE accessing a target cell; and transmitting, to other network nodes and/or the UE, a message including a third indication, wherein the third indication is used to indicate keeping the resource of the source cell.

For example, in some embodiments, the method further includes, when the first network node is not a master node (MN), transmitting a message including a resource configuration information of the source cell to the MN.

For example, in some embodiments, the message further includes a third indication, and the third indication is used to indicate keeping the resource of the source cell.

For example, in some embodiments, the method further includes: making a decision of enhancing mobility by the first network node, wherein the decision of enhancing mobility includes enhanced Conditional PSCell Change (CPC), enhanced Conditional PSCell Addition (CPA) or enhanced Conditional Handover (CHO).

According to some embodiments of the present disclosure, a method performed by a second network node in a wireless communication system is provided. The method includes transmitting a message including a first indication to a user equipment (UE), wherein the first indication is used to indicate keeping resources of candidate cells.

For example, in some embodiments, the second network node further receives the message including the first indication from other network nodes.

For example, in some embodiments, the message further includes a third indication, and the third indication is used to indicate keeping the resource of the source cell.

For example, in some embodiments, the first indication is further used to indicate releasing resources of the candidate cells that the UE has accessed once.

For example, in some embodiments, the method further includes releasing resource of a source cell after the UE accessing a target cell.

For example, in some embodiments, after releasing the resource of the source cell, the method further includes: transmitting a message including a second indication to the UE; and transmitting a message including the resource configuration information of the source cell to the UE, wherein the second indication is used to indicate keeping the resource of the source cell until the source cell is selected as a target cell for cell access, and wherein the message including the resource configuration information of the source cell and the message including the second indication are the same message or different messages.

For example, in some embodiments, the method further includes: releasing resource of a source cell after the UE accessing a target cell; transmitting a message including a third indication to the UE; and transmitting a message including the resource configuration information of the source cell to the UE, wherein the third indication is used to indicate keeping the resource of the source cell, and wherein the message including the resource configuration information of the source cell and the message including the third indication are the same message or different messages.

It should be noted, the first network node and the second network node mentioned above may be the same network node (e.g., a master node (MN)), or may be two different network nodes in the communication system (e.g., the first network node is a gNB-CU, and the second network node is a MN).

According to some embodiments of the present disclosure, a terminal is also provided. The terminal includes a transceiver and a processor. The processor is coupled to the transceiver and is configured to perform the method of some embodiments as mentioned above.

According to some embodiments of the present disclosure, a network node is also provided. The network node includes a transceiver and a processor. The processor is coupled to the transceiver and is configured to perform the method of some embodiments as mentioned above.

According to some embodiments of the present disclosure, a computer-readable storage medium with one or more computer programs stored thereon is also provided, wherein when the one or more computer programs are executed by one or more processors, the method of some embodiments as described above is implemented.

### BRIEF DESCRIPTION OF DRAWINGS

For a more complete illustration to the technical solution of the present disclosure, a brief introduction is now made to the following accompanying drawings of the embodiments. Obviously, the accompanying drawings in the following description merely relate to some embodiments of the present disclosure, and are not intended to limit the present disclosure, in which:

FIG. 1 illustrates an exemplary system architecture of system architecture evolution (SAE) in accordance with various embodiments of the present disclosure;

FIG. 2 illustrates an exemplary system architecture in accordance with various embodiments of the present disclosure;

FIG. 3A illustrates a flowchart of a method performed by a user equipment (UE);

FIG. 3B illustrates a flowchart of a method performed by a network node;

FIG. 4A illustrates a flowchart of alternative 1 and alternative 2;

FIG. 4B and FIG. 4C illustrate a diagram of alternative 1 and alternative 2 of a UE performing enhanced Conditional PSCell Change (CPC) Intra-Distributed Unit (Intra-DU) of a Secondary Node (SN) in accordance with various embodiments of the present disclosure;

FIG. 5A illustrates a flowchart of alternative 3;

FIG. 5B illustrates a flowchart of alternative 4;

FIG. 5C, FIG. 5D, and FIG. 5E illustrate a diagram of alternative 3 and alternative 4 of a UE performing enhanced CPC Intra-Distributed Unit (Intra-DU) of a SN in accordance with various embodiments of the present disclosure;

FIG. 6A and FIG. 6B illustrate a diagram of alternative 1 and alternative 2 of a UE performing enhanced CPC Inter-Distributed Unit (Inter-DU) of a SN in accordance with various embodiments of the present disclosure;

FIG. 7A, FIG. 7B, and FIG. 7C illustrate a diagram of alternative 3 and alternative 4 of a UE performing enhanced CPC Inter-Distributed Unit (Inter-DU) of a SN in accordance with various embodiments of the present disclosure;

FIG. 8A, FIG. 8B, and FIG. 8C illustrate a diagram of alternative 1 and alternative 2 of a UE performing enhanced Conditional PSCell Addition (CPA) and enhanced CPC Inter-SN in accordance with various embodiments of the present disclosure;

FIG. 9A, FIG. 9B, and FIG. 9C illustrate a diagram of alternative 3 of a UE performing enhanced CPA and enhanced CPC Inter-SN in accordance with various embodiments of the present disclosure;

FIG. 10A and FIG. 10B illustrate a diagram of alternative 1 and alternative 2 of a UE performing enhanced CPC initiated by a Master Node (MN) Inter-SN in accordance with various embodiments of the present disclosure;

FIG. 11A, FIG. 11B, and FIG. 11C illustrate a diagram of alternative 3 and alternative 4 of a UE performing enhanced CPC initiated by a MN Inter-SN in accordance with various embodiments of the present disclosure;

FIG. 12A and FIG. 12B illustrate a diagram of alternative 1 and alternative 2 of a UE performing enhanced CPC initiated by a SN Inter-SN in accordance with various embodiments of the present disclosure;

FIG. 13A, FIG. 13B, and FIG. 13C illustrate a diagram of alternative 3 and alternative 4 of a UE performing enhanced CPC initiated by a SN Inter-SN in accordance with various embodiments of the present disclosure;

FIG. 14A, FIG. 14B, and FIG. 14C illustrate a diagram of alternative 1 and alternative 2 of a UE performing enhanced Conditional Handover (CHO) inter-base station nodes (Inter-gNB) in accordance with various embodiments of the present disclosure;

FIG. 15A, FIG. 15B, FIG. 15C, and FIG. 15D illustrate illustrates a diagram of alternative 3 and alternative 4 of a UE performing enhanced CHO Inter-gNB in accordance with various embodiments of the present disclosure;

FIG. 16 illustrates a block diagram of a configuration of a terminal in accordance with various embodiments of the present disclosure; and

FIG. 17 illustrates a block diagram of a configuration of a base station in accordance with various embodiments of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

In the embodiments of the present disclosure, CHO (Conditional Handover) may be a conditional handover. That is, the handover procedure will be performed only when the evaluation condition is met. Based on the measurement report of a UE, the network pre-configures the resources of multiple candidate target cells (which may be the same base station or different base stations), and transmits the corresponding resource and measurement configuration of each cell to the UE in advance. The UE stores the corresponding resource of each cell and performs measurement to evaluate the conditions. When a certain cell is found to meet the condition, the UE detaches from the source cell, and successfully accesses the cell and applies the corresponding configuration. The UE then releases all the configurations of other candidate cells; meanwhile, the node to which the target cell belongs informs the source node which cell has been selected. Then, the network side performs releasing all the configurations of the other candidate cells.

In the embodiments of the present disclosure, MN (Master Node) may be a master base station used in the scenario of UE multi-connection, which provides control plane connection and the core network.

In the embodiments of the present disclosure, MCG (Master Cell Group) may be a cell group in a master base station that serves the UE in the scenario of UE dual connectivity or multi-connection, which includes at least one PCell (the primary cell in a master cell group) and possibly one or more SCells (the secondary cell(s)).

In the embodiments of the present disclosure, SN (Secondary Node) may be a secondary base station used in the scenario of UE multi-connection, which does not have control plane connection and the core network.

In the embodiments of the present disclosure, SCG (Secondary Cell Group) may be a cell group in a secondary base station that serves the UE in the scenario of UE dual connectivity or multi-connection, which includes at least one PSCell (the primary cell in the secondary cell group) and possibly one or more SCells (the secondary cell(s)).

In the embodiments of the present disclosure, MR-DC (Multi-Radio Dual Connectivity) can refer to, in the scenario of UE dual connectivity, the wireless technologies of the master base station and the secondary base station that serve the UE are different. For example, one is 4G and the other is 5G.

In the embodiments of the present disclosure, NR-DC (NR-NR Dual Connectivity) can refer to, in the scenario of UE dual connectivity, both the master base station and the secondary base station that serve the UE are 5G NR (New Radio) base stations gNB.

In the embodiments of the present disclosure, 5GC (5G Core) may be a network element of the 5G core network, which is responsible for 5G base station access and mobility management, session management with PDUs, etc.

In the embodiments of the present disclosure, gNB (next Generation Node B) may be a next-generation base station node, and currently refers to a 5G NR (New Radio) base station.

In the embodiments of the present disclosure, DU (Distributed Unit) may be used with gNB-DU interchangeably. For example, the DU may have functions such as Radio Link Control (RLC) protocol, Media Access Control (MAC) protocol, and Physical Layer (Physical, PHY) protocol.

In the embodiments of the present disclosure, CU (Central Unit) may be used with gNB-CU interchangeably. For example, the CU may have functions such as Radio Resource Control (RRC), Service Data Adaptation Protocol (SDAP) and Packet Data Convergence Protocol (PDCP) protocol layer.

In the embodiments of the present disclosure, CU-CP (Central Unit-Control Plane) may be a logical node in which the central unit is responsible for RRC and PDCP protocol control plane, and is sometimes also referred to as gNB-CU-CP. The CU-CP is connected to DU via F1-C interface, and to CU-UP via E1 interface.

In the embodiments of the present disclosure, CU-UP (Central Unit-User Plane) may be a logical node in which the central unit is responsible for SDAP protocol and PDCP protocol user plane, and is sometimes also referred to as gNB-CU-UP. The CU-UP is connected to DU via F1-U interface, and to CU-CP via E1 interface.

In the embodiments of the present disclosure, CPA (Conditional PSCell Addition) may be a conditional secondary cell addition. That is, the secondary cell addition procedure will be executed only when the evaluation condition is met. Based on the measurement report of a UE, MN pre-configures the resources of multiple candidate target secondary cells and transmits the corresponding resource and measurement configuration of each secondary cell to the UE in advance. The UE stores the corresponding resource of each secondary cell and performs measurement to evaluate the conditions. When a certain secondary cell is found to meet the conditions, the UE applies the corresponding configuration of the cell to establish a dual connectivity scenario. Then, the MN is informed the selected secondary cell through signalling. The MN then releases all the configurations of other candidate cells.

In the embodiments of the present disclosure, CPC (Conditional PSCell Change) may be a conditional secondary cell change. That is, the secondary cell change procedure will be performed only when the evaluation conditions are met. There are two scenarios: Rel-16 intra-SN CPC and Rel-17 inter-SN CPC. For Rel-16 intra-SN CPC, based on the measurement report of a UE, SN pre-configures the resources of multiple candidate secondary cells in the SN, and transmits the corresponding resource and measurement configuration of each secondary cell to the UE in advance. The UE stores the corresponding resource of each secondary cell and performs measurement to evaluate the conditions. When a certain secondary cell is found to meet the conditions, the UE detaches from the source secondary cell and applies the corresponding configuration of the target secondary cell to maintain the dual connectivity scenario. Then, the SN releases all the configurations of other candidate cells through signalling. For Rel-17 inter-SN CPC, based on the measurement report of the UE, MN or SN pre-configures the resources of multiple candidate secondary cells of the SN on the network side, and transmits the corresponding resource and measurement configuration of each secondary cell to the UE in advance. The UE stores the corresponding configuration of each secondary cell and performs measurement. When a certain secondary cell is found to meet the conditions, the UE detaches from the source secondary cell and applies the corresponding configuration of the target secondary cell to maintain the dual connectivity scenario. Then, the MN is informed the selected secondary cell through signalling. The MN then releases all the configurations of other candidate cells.

In the embodiments of the present disclosure, keeping resource of a cell can also be understood as maintaining the resource of the cell or not releasing the resource of the cell, wherein the cell includes candidate cells and/or the source cell.

In the embodiments of the present disclosure, the first indication may be used to indicate keeping resources of all the candidate cells, and may also be used to indicate keeping resources of candidate cells that have not been accessed, wherein the cells that have not been accessed can also be understood as unselected cells.

In the embodiments of the present disclosure, the first indication and the third indication may be the same indication. That is, one indication is used to indicate keeping the resources of the candidate cells and the resource of the source cell. For example, the indication may be a UE-based indication, and one field in the message is used to indicate keeping the resources of the candidate cells and the resource of the source cell. The first indication and the third indication may also be different indications. For example, the first indication may be an indication based on the candidate cells, and the third indication may be an indication based on the source cell.

In the embodiments of the present disclosure, the candidate cell selected and successfully accessed by the UE is the cell currently serving the UE. In the next round of CPC/CHO, the cell will serve as a source cell of the UE, and correspondingly, the base station node to which the cell belongs will also serve as a source base station node.

In the embodiments of the present disclosure, after one round of CPC/CHO and UE accesses another cell, the source cell serving the UE will serve as the candidate cell of the UE in the next round of CPC/CHO.

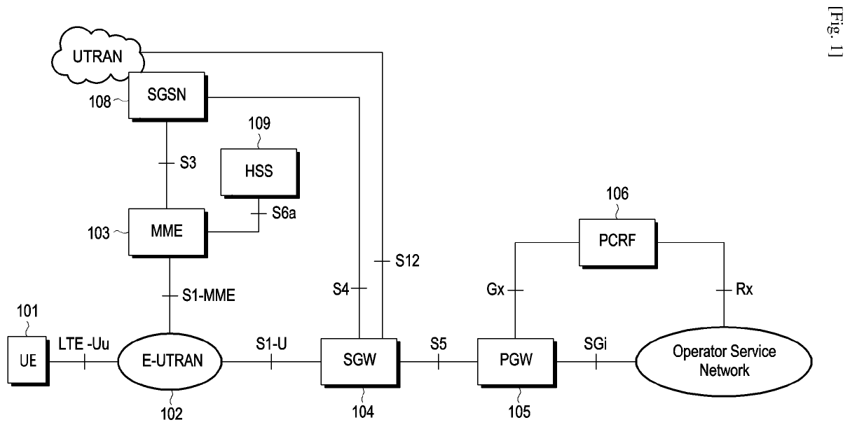

FIGS. 1 to 17 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

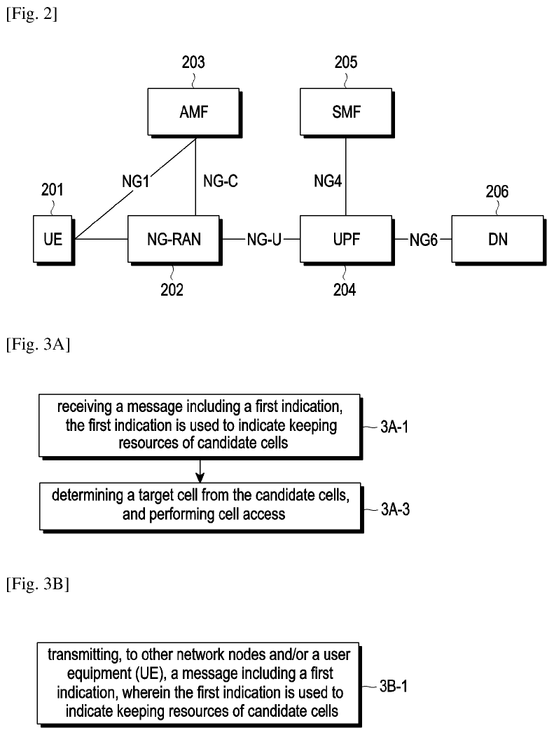

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-eNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

FIG. 3A illustrates a flowchart of a method performed by a user equipment (UE). FIG. 3B illustrates a flowchart of a method performed by a network node.

Referring to FIG. 3A, in step 3A-1, the UE receives a message including a first indication, the first indication is used to indicate keeping resources of candidate cells. In step 3A-3, the UE determines a target cell from the candidate cells and performs cell access.

Referring to FIG. 3B, in step 3B-1, the network node transmits a message including a first indication to other network nodes and/or the user equipment (UE), wherein the first indication is used to indicate keeping the resources of candidate cells.

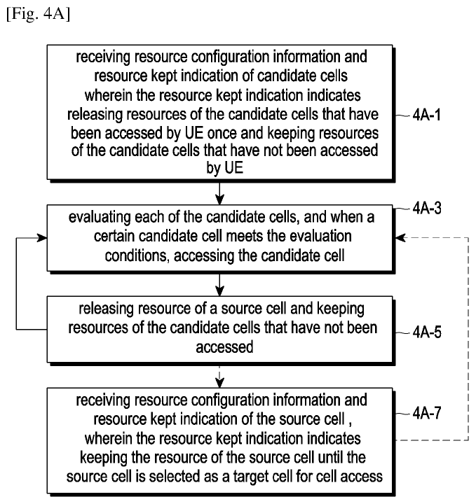

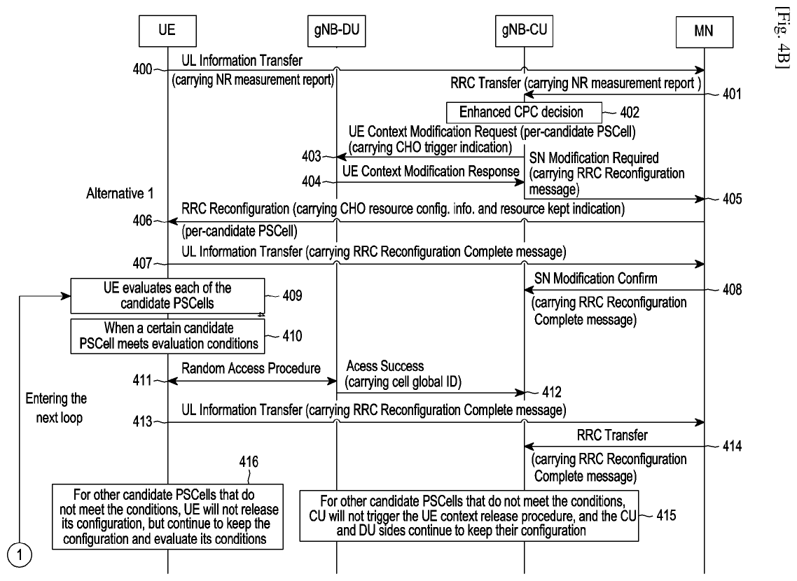

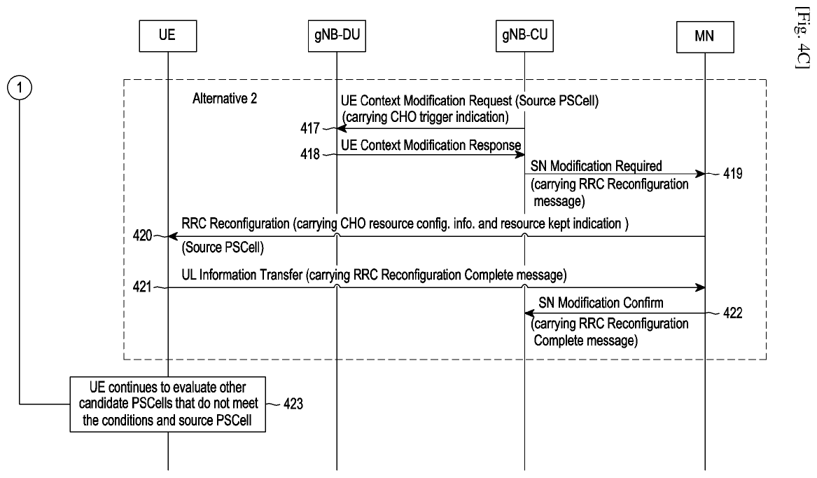

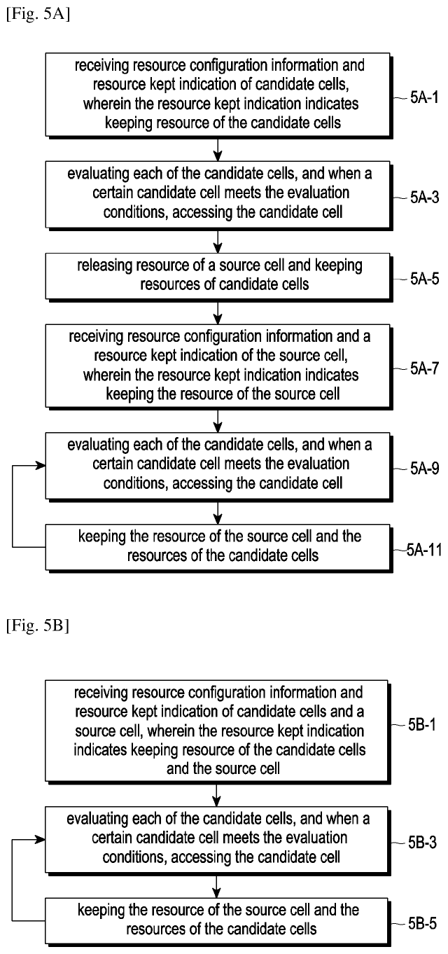

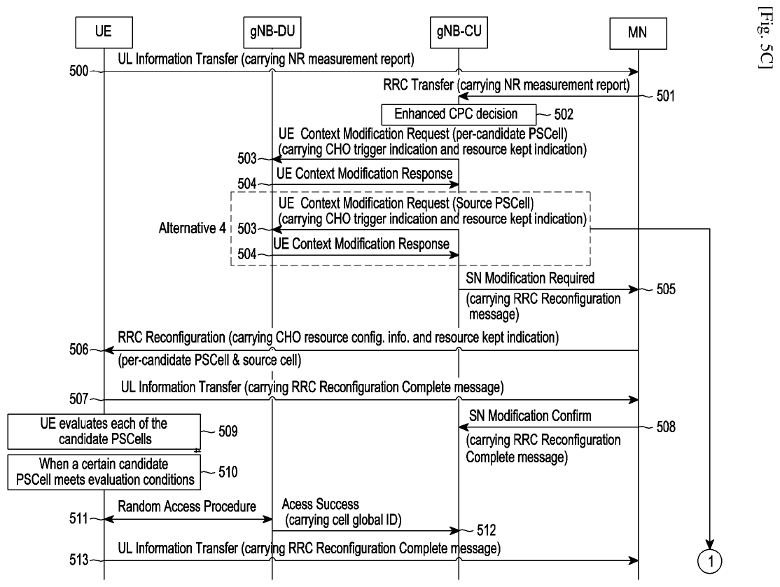

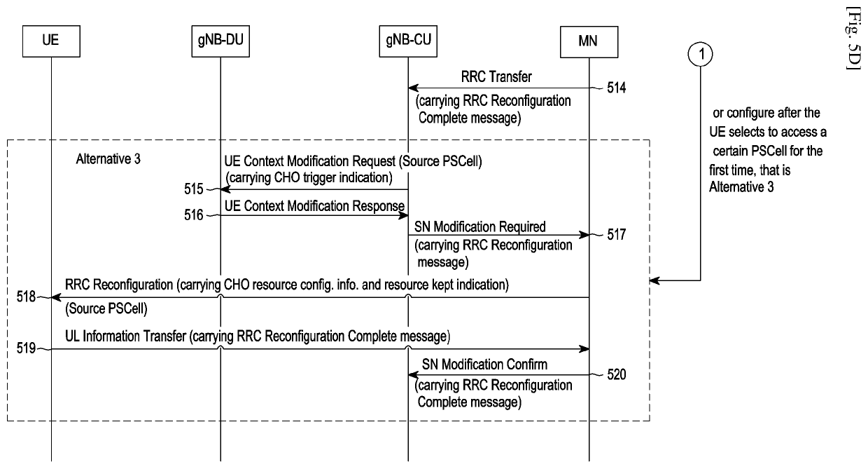

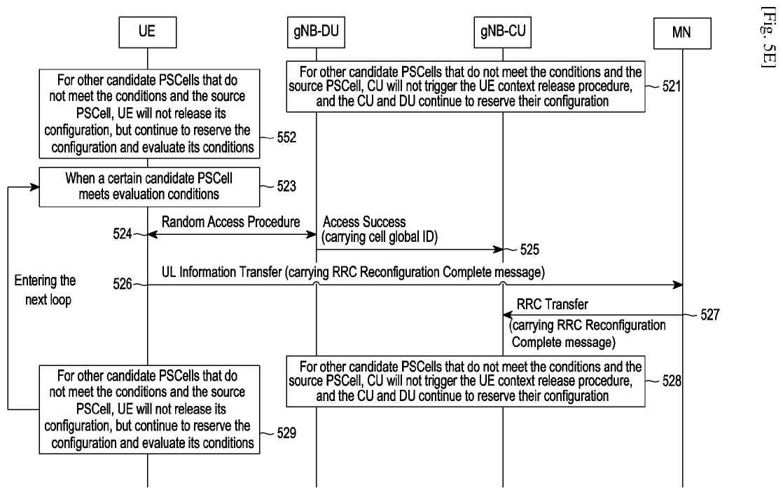

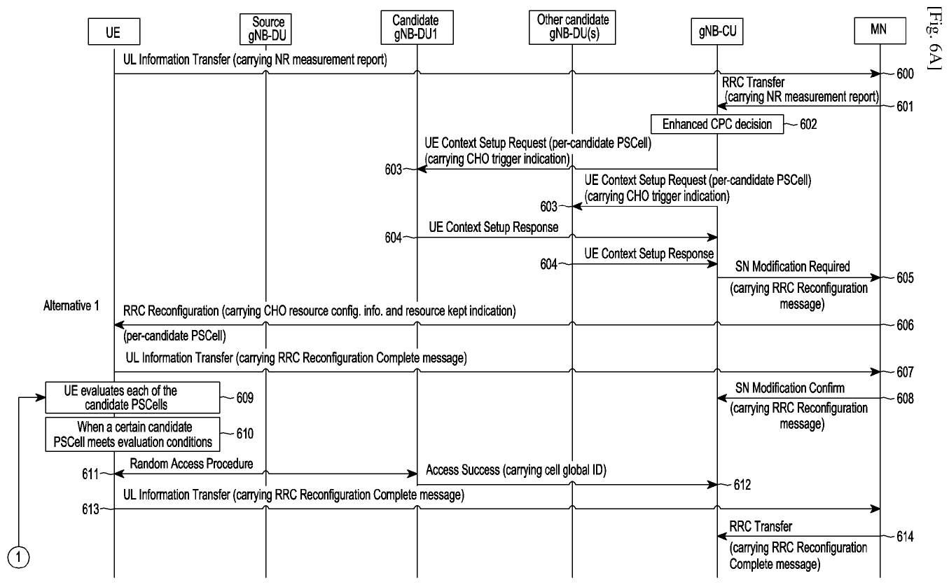

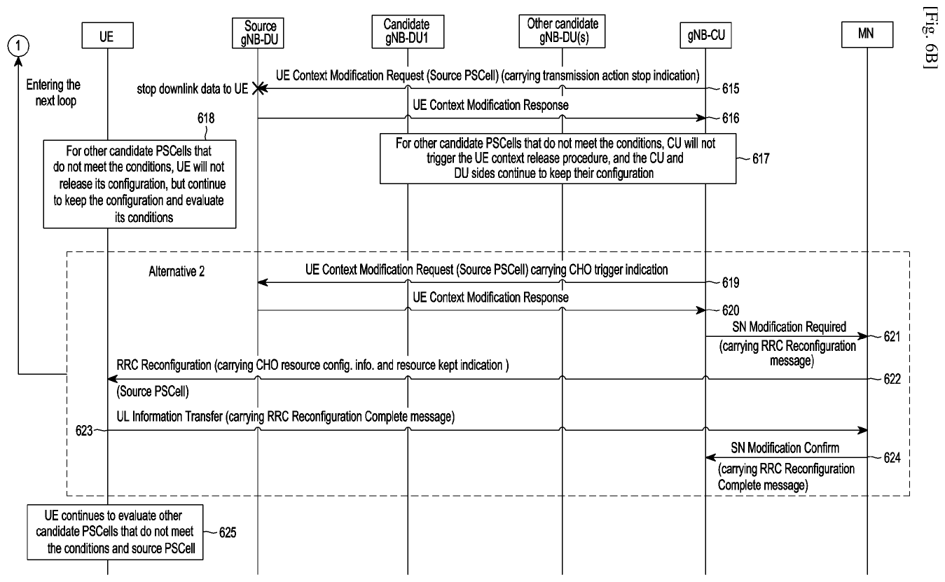

FIG. 4A illustrates a flowchart of alternative 1 and alternative 2. FIG. 4B and FIG. 4C illustrate a diagram of the user equipment (UE) performing enhanced Conditional PSCell Change (CPC) Intra-Distributed Unit (Intra-DU) of a Secondary Node (SN) in accordance with various embodiments of the present disclosure, wherein FIG. 4B and FIG. 4C illustrate the alternative 1 and the alternative 2.

In alternative 1, after the UE performs CPC once, the network side and the UE side release the resource of the source PSCell, which will no longer be used as the candidate PSCell for the next CPC. Other unselected candidate PSCells keep their resources at the network side and the UE side, and the unselected candidate PSCells will be used as candidate PSCells for the next CPC. Only the resource of a candidate PSCell which is selected by the UE and used once will be released after the UE performs the next CPC and accesses the other PSCells.

In alternative 2, after the UE performs CPC once, the resource of the source PSCell are reconfigured at the network side and the UE side through signalling, and the source PSCell will be used as the candidate PSCell for the next CPC. Resources of other unselected candidate PSCells are kept at the network side and the UE side, and unselected candidate PSCells will be used as candidate PSCells for the next CPC. Only the resource of a candidate PSCell which is selected by the UE and used once will be released after the UE performs the next CPC and accesses other PSCells.

Referring to FIG. 4A, in step 4A-1, the UE receives the resource configuration information and resource kept indication of candidate cells, wherein the resource kept indication is used to indicate releasing resource of the candidate cell that the UE has accessed once and keeping the resources of the candidate cells that the UE has not accessed.

In step 4A-3, the UE evaluates each candidate cell, and when a certain candidate cell meets the evaluation conditions, the UE accesses the candidate cell.

In step 4A-5, the UE releases the resource of the source cell and keeps the resources of the candidate cells that have not been accessed.

For alternative 1, it may go back to step 4A-3 and start looping. For alternative 2, proceed to steps 4A-7.

In step 4A-7, the UE receives resource configuration information and a resource kept indication of the source cell, wherein the resource kept indication indicates keeping the resource of the source cell until the source cell is selected as the target cell for cell access. Then, it may go back to step 4A-3 and start looping.

For example, referring to FIG. 4B and FIG. 4C, in step 400, the user equipment (UE) transmits a new radio (NR) measurement report to the master node (MN). In step 401, the MN forwards the NR measurement report to the central unit (gNB-CU) of the secondary node (SN).

In step 402, the gNB-CU of the SN makes the decision of performing enhanced CPC. That is, after the UE performs CPC once, the resources of the candidate secondary cells (PSCells) which have not been selected by the UE will not be released immediately due to not being selected (except for special cases, the DU and CU initiate a release request or decision for a corresponding candidate PSCell due to some other reasons), but continue to be kept as the candidate PSCells for the next CPC. Only when being selected by the UE and used once, the resource of a candidate PSCell will be released after the UE performs the next CPC and accesses other PSCells. It can be understood that, the resources of the candidate PSCells are kept if not used and will be released after being selected and used once.

In step 403, the gNB-CU of the SN transmits a UE Context Modification Request message to the gNB-DU of the SN. In step 404, the gNB-DU of the SN transmits a UE Context Modification Response message to the gNB-CU of the SN. The gNB-CU and gNB-DU of the SN perform resource configuration for each candidate PSCell through the UE context modification procedure.

In step 405, the gNB-CU of the SN transmits a SN Modification Required message carrying an RRC Reconfiguration message to the MN. In step 406, the MN transmits the RRC Reconfiguration message to the UE, wherein the RRC Reconfiguration message carries the resource configuration information and the evaluation condition measurement configuration (determined by the gNB-CU of the SN) of each candidate PSCell. The RRC Reconfiguration message may also carry at least one indication of:
for example, a conditional RRC reconfiguration kept indication (condRRCReconfigKeptIndicatior=“true”). This indication may indicate based on the UE or based on the candidate PSCell. It is used to control the behaviors of the UE, that is, after the UE performs CPC once, at the UE side, it continues to keep the resources of the unselected candidate PSCells as the candidate PSCells of the next CPC. Only when being selected by the UE and used once, after the UE performs the next CPC and accesses the other PSCells, the resource of the candidate PSCell will be released. It can be understood that, the resources of the candidate PSCells are kept if not used and will be released after being selected and used once.

In step 407, the UE transmits an UL Information Transfer message carrying an RRC Reconfiguration Complete message to the MN after establishing the corresponding resources according to the resource configuration information. In step 408, the MN transmits an SN Modification Confirm message carrying the RRC Reconfiguration Complete message to the gNB-CU of the SN.

In step 409 and step 410, the UE measures and evaluates each candidate PSCell. When a certain PSCell meets the evaluation conditions, the UE starts to access the target PSCell and utilize the corresponding resource. The target PSCell is the PSCell that meets the evaluation conditions as mentioned above.

In step 411, the UE successfully accesses the target PSCell and utilizes the corresponding resource. Meanwhile, since the UE obtains the conditional RRC reconfiguration kept indication in the configuration of step 406, the UE performs the behavior of continuing to keep the resources and the evaluation condition measurement configuration of other unselected candidate PSCells.

In step 412, the gNB-DU transmits the cell global ID information of the target PSCell successfully accessed by the UE to the gNB-CU. At this time, since the gNB-CU of the SN decides to perform enhanced CPC, that is, after the UE performs CPC once, the resources of the unselected candidate PSCells will not be released immediately due to not being selected (except for special cases, the DU and CU initiate a release request or decision due to some other reasons) but continue to be kept as the candidate PSCells for the next CPC.

In step 413, after the UE successfully accesses the target PSCell, the UE transmits an UL Information Transfer message carrying an RRC Reconfiguration Complete message to the MN. In step 414, the MN transmits an RRC Transfer message carrying the RRC Reconfiguration Complete message to the gNB-CU of the SN.

In step 415 and step 416, at the network side, the gNB-DU and gNB-CU continue to keep the resources of the candidate PSCells not selected by the UE, and the UE side continues to keep the resources and evaluation condition measurement configuration of other unselected candidate PSCells as the candidate PSCells for the next CPC.

In steps 417 to 422 (for alternative 2), the resource configured for the source PSCell is released at the UE side after the UE performs CPC once, and meanwhile, at the network side, after learning that the UE successfully accesses the target PSCell (step 412), the gNB-CU will also trigger the UE context release procedure to release the resource of the source PSCell later. Therefore, after the UE accesses the target PSCell, if the source PSCell needs to be used as a candidate cell for the next CPC, the gNB-CU should configure resource for the source PSCell as the candidate cell through the UE context modification procedure, and then configure the resource of the source PSCell to the UE. Similar to the steps 403 to 408 for the configuration of a candidate PSCell, steps 417 to 422 are for the configuration of the source PSCell. On the same principle, in step 420, the RRC Reconfiguration message includes the resource configuration information and the evaluation condition measurement configuration of the source PSCell. The RRC Reconfiguration message may also include one indication of:
for example, a conditional RRC reconfiguration kept indication (condRRCReconfigKeptIndicatior=“true”). This indication may indicate based on the UE or based on the source PSCell. It is used to control the behaviors of the UE, that is, after the UE performs CPC once, the resource of the unselected source PSCell continues to be kept as the candidate PSCell of the next CPC. Only when being selected by the UE and used once, after the UE performs the next CPC and accesses other PSCells, the resource of the source PSCell will be released. It can be understood that, the resource of the source PSCell is kept if not used and will be released after being selected and used once.

In step 423, for the next round of CPC, the UE continues to measure and evaluate all candidate PSCells including the unselected candidate PSCells in the last CPC and the source PSCell (configured through steps 417 to 422). For performing each CPC, the following procedure may proceed to step 409 and start looping.

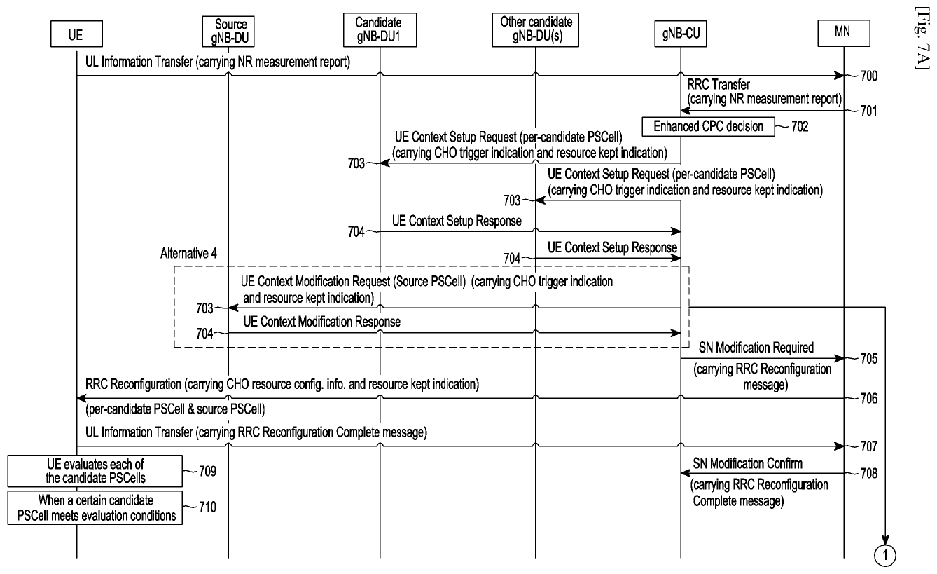

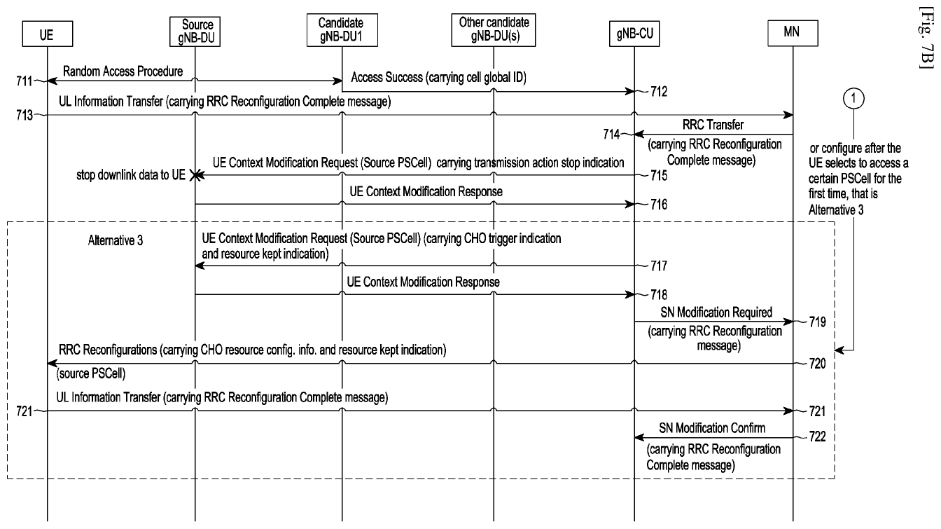

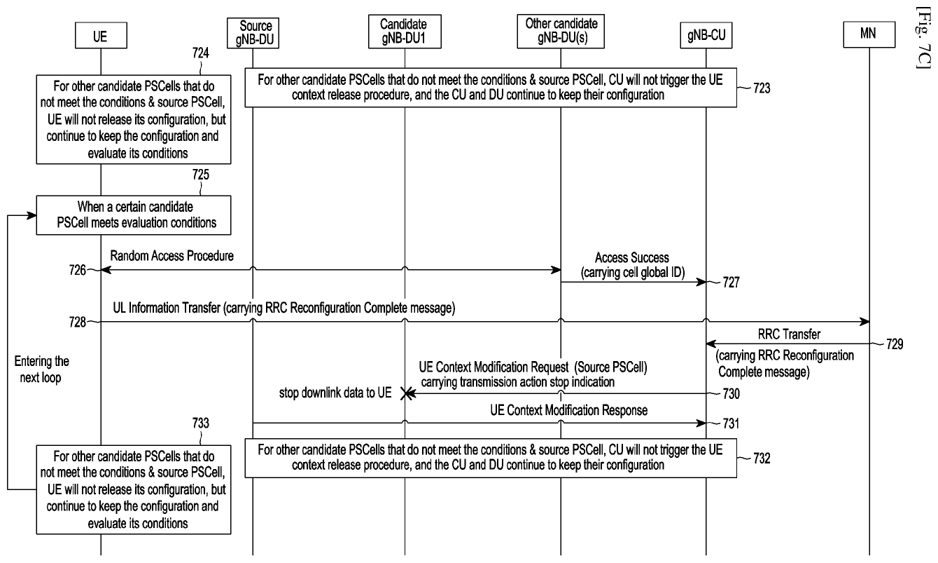

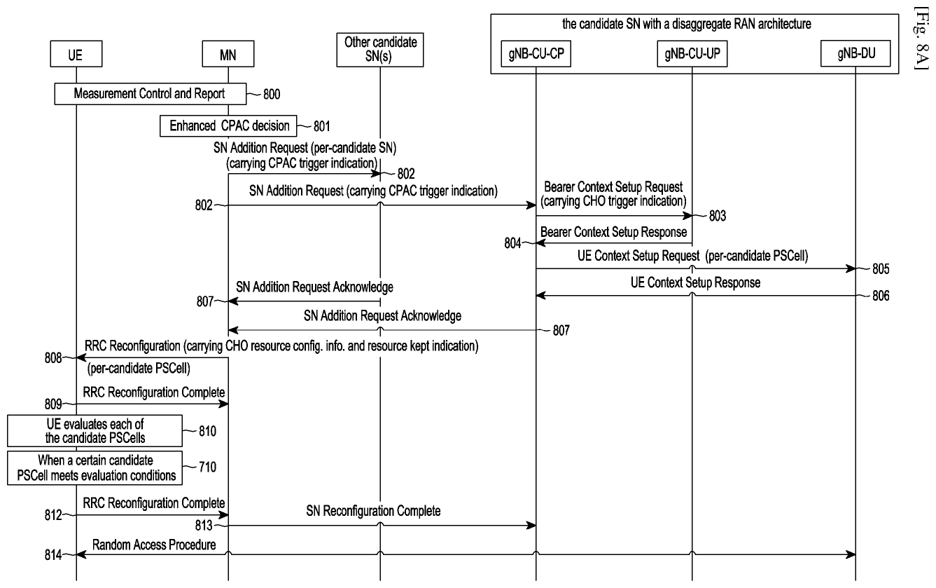

FIG. 5A illustrates a flowchart of alternative 3. FIG. 5B illustrates a flowchart of alternative 4. FIG. 5C, FIG. 5D, and FIG. 5E illustrates a diagram of a UE performing enhanced Conditional PSCell Change (CPC) Intra-Distributed Unit (Intra-DU) of a SN in accordance with various embodiments of the present disclosure, wherein FIG. 5C, FIG. 5D, and FIG. 5E illustrate alternative 3 and alternative 4.

In alternative 3, after performing CPC once, the resources of the source PSCell and all the candidate PSCells are kept at the network side and the UE side all the time. That is, after the UE performs CPC once and accesses to a certain candidate PSCell, the source PSCell is then used as the candidate PSCell for the next CPC. Regarding the configuration occasion of the source PSCell, in this alternative, it is configured after the UE performs the first CPC.

In alternative 4, after performing CPC once, the resources of the source PSCell and all the candidate PSCells are kept at the network side and the UE side all the time. That is, after the UE performs CPC once and accesses to a certain candidate PSCell, the source PSCell is then used as the candidate PSCell for the next CPC. Regarding the configuration occasion of the source PSCell, in this solution, the source PSCell and the candidate PSCells are configured together when the CPC is initially configured.

For alternative 3, referring to FIG. 5A, in step 5A-1, the UE receives the resource configuration information and a resource kept indication of candidate cells, wherein the resource kept indication is used to indicate keeping the resource of the candidate cells.

In step 5A-3, the UE evaluates each candidate cell, and when a certain candidate cell meets the evaluation condition, the UE accesses the candidate cell.

In step 5A-5, the UE releases the resource of the source cell and keeps the resources of the candidate cells.

In step 5A-7, the UE receives resource configuration information and resource kept indication of the source cell, wherein the resource kept indication is used to indicate keeping the resource of the source cell.

In step 5A-9, the UE evaluates each candidate cell and the source cell, and when a certain cell (including the candidate cells and the source cell) meets the evaluation conditions, the UE accesses the cell.

In step 5A-11, the UE keeps the resources of the source cell and the candidate cells. Then, the procedure may go back to step 5A-9 and start looping.

For alternative 4, referring to FIG. 5B, in step 5B-1, the UE receives the resource configuration information and resource kept indication of candidate cells and the source cell, wherein the resource kept indication is used to indicate keeping the resources of the candidate cells and the source cell.

In step 5B-3, the UE evaluates each candidate cell, and when a certain candidate cell meets the evaluation condition, the UE accesses the candidate cell.

In step 5B-5, the UE keeps the resources of the source cell and the candidate cells. Then, the procedure may go back to step 5B-3 and start looping.

The specific signal flow can refer to FIG. 5C, FIG. 5D, and FIG. 5E. In step 500, the UE transmits a new radio (NR) measurement report to the master node (MN). In step 501, the MN forwards the NR measurement report to the central unit (gNB-CU) of the secondary node (SN).

In step 502, the gNB-CU of the SN makes the decision of performing enhanced CPC. That is, after the UE performs CPC once, the resources of the unselected candidate PSCells and the source PSCell will not be released immediately (except for special cases, the DU and CU initiate a release request or decision for a corresponding candidate PSCell due to some other reasons) but continue to be kept as the candidate PSCells for the next CPC. That is, the resources of the candidate PSCells and the source PSCell are kept at the gNB-CU and gNB-DU side all the time.

In step 503, the gNB-CU of the SN transmits a UE Context Modification Request message to the gNB-DU of the SN. In step 504, the gNB-DU of the SN transmits a UE Context Modification Response message to the gNB-CU of the SN. The gNB-CU and gNB-DU of the SN perform resource configuration for each candidate PSCell through the UE context modification procedure. Meanwhile, for the source PSCell, when the UE preforms CPC once and accesses to one of the candidate PSCells, it may need to configure the source PSCells as the candidate PSCells for the next round of CPC. Thus, the gNB-CU configures resource for the source PSCell as the candidate PSCell through the UE context modification procedure, the resource of the source PSCell is then configured to the UE along with the resource of the candidate PSCell. Wherein, the UE Context Modification Request message may carry at least one indication of:
for example, CHO resource or context kept indication (CHO resource/context Kept Indicator=“true”). This indication indicates based on the candidate PSCell and the source PSCell. It is used to control the behaviors of the DU, that is, after the UE performs CPC once, the resources of the unselected candidate PSCells and the source PSCell continue to be kept as the candidate PSCells of the next CPC. That is, the resources of the candidate PSCells and the source PSCell are kept at the gNB-CU and gNB-DU side all the time.

In step 505, the gNB-CU of the SN transmits a SN Modification Required message carrying an RRC Reconfiguration message to the MN. In step 506, the MN transmits the RRC Reconfiguration message to the UE. The gNB-CU of the SN configures the UE through MN, wherein the RRC Reconfiguration message carries the resource configuration information and the evaluation condition measurement configuration (determined by the gNB-CU of the SN) of each candidate PSCell and the source PSCell (i.e., the PSCell currently serving the UE). The RRC Reconfiguration message may also carry at least one indication of:
for example, a conditional RRC reconfiguration kept indication (condRRCReconfigKeptIndicatior=“true”). This indication may indicate based on the UE or based on the candidate PSCell and the source PSCell. It is used to control the behaviors of the UE, that is, after the UE performs CPC once, the resources of the unselected candidate PSCells and the source PSCell continue to be kept as the candidate PSCells of the next CPC. That is, the resources and the evaluation condition measurement configuration of the candidate PSCells and the source PSCell are kept at the UE side all the time, unless the network side initiates the release.

In step 507, after obtaining and storing the resources, the UE transmits an UL Information Transfer message carrying an RRC Reconfiguration Complete message to the MN. In step 508, the MN transmits an SN Modification Confirm message carrying the RRC Reconfiguration Complete message to the gNB-CU of the SN.

In steps 509 and 510, the UE measures and evaluates each candidate PSCell. When a certain PSCell meets the evaluation conditions, the UE starts to access a target PSCell and utilize the corresponding resource.

In step 511, the UE successfully accesses the target PSCell and utilizes the corresponding resource. Meanwhile, since the UE obtains the conditional RRC reconfiguration kept indication when being configurated through step 506, the UE performs the behavior of continuing to keep the resources and the evaluation condition measurement configuration of other unselected candidate PSCells and the source PSCell.

In step 512, the gNB-DU transmits the cell global ID information of the target PSCell successfully accessed by the UE to the gNB-CU. At this time, since the gNB-CU of the SN decides to perform enhanced CPC, that is, after the UE performs CPC once, the resources of the unselected candidate PSCells and the source PSCell will not be released immediately (except for special cases, the DU and CU initiate a release request or decision for a corresponding candidate PSCell due to some other reasons) but continue to be kept as the candidate PSCells for the next CPC. That is, the resources of the candidate PSCells and the source PSCell are kept at the gNB-CU and gNB-DU side all the time.

In step 513, after the UE successfully accesses the target PSCell, the UE transmits an UL Information Transfer message carrying an RRC Reconfiguration Complete message to the MN. In step 514, the MN transmits an RRC Transfer message carrying the RRC Reconfiguration Complete message to the gNB-CU of the SN.

In steps 515 to 520 (for alternative 3), if the source PSCell and candidate PSCells are not pre-configured together in steps 503 to 508, the resource configuration for the source PSCell can be considered after the UE performs CPC for the first time. Therefore, after the UE successfully accesses the target PSCell, the gNB-CU configures resource for the source PSCell as the candidate PSCell through the UE context modification procedure, which is then again configured to the UE. Similar to the steps 503 to 508 for the configuration of a candidate PSCell, steps 515 to 520 are for the configuration of the source PSCell. The UE Context Modification Request message may carry one indication of:
for example, CHO resource or context kept indication (CHO resource/context Kept Indicator=“true”). This indication indicates based on the source PSCell. It is used to control the behaviors of the DU, that is, after the UE performs CPC once, the resource of the source PSCell continues to be kept as the candidate PSCell of the next CPC. That is, the resource of the source PSCell is kept at the gNB-CU and gNB-DU side all the time.

In step 518, the MN transmits the RRC Reconfiguration message to the UE, wherein the RRC Reconfiguration message carries the resource configuration information of and the evaluation condition measurement configuration the source PSCell. The RRC Reconfiguration message may also carry at least one indication of:
for example, a conditional RRC reconfiguration kept indication (condRRCReconfigKeptIndicatior=“true”). This indication may indicate based on the UE or based on the source PSCell. It is used to control the behaviors of the UE, that is, after the UE performs CPC once, the resource of the source PSCell continue to be kept as the candidate PSCell of the next CPC. That is, the resource and the evaluation condition measurement configuration of the source PSCell are kept at the UE side all the time, unless the network side initiates the release.

In steps 521 and 525, at the network side, the gNB-DU and gNB-CU continue to keep the resources of the candidate PSCells not selected by the UE and the source PSCell, and the UE side continues to keep the resources and evaluation condition measurement configuration of other unselected candidate PSCells and the source PSCell as the preparation for the next CPC.

In step 523, for the next round of CPC, the UE continues to measure and evaluate all candidate PSCells including the unselected candidate PSCells in the last CPC and the source PSCell (configured through steps 503 to 508, or steps 515 to 520).

In steps 524 to 529, for each CPC, similar processes are performed on both the UE side and the network side. After UE evaluates the conditions, selects a target PSCell meeting the conditions and successfully accesses the target PSCell, other candidate PSCells and the source PSCell serve as the candidate cells for the next CPC and their resources are kept on the UE side and the network side all the time (unless for special cases, the gNB-DU or the gNB-CU initiates a release request or decision for a corresponding candidate PSCell due to some other reasons). Then, the procedure may proceed to step 523 and start looping.

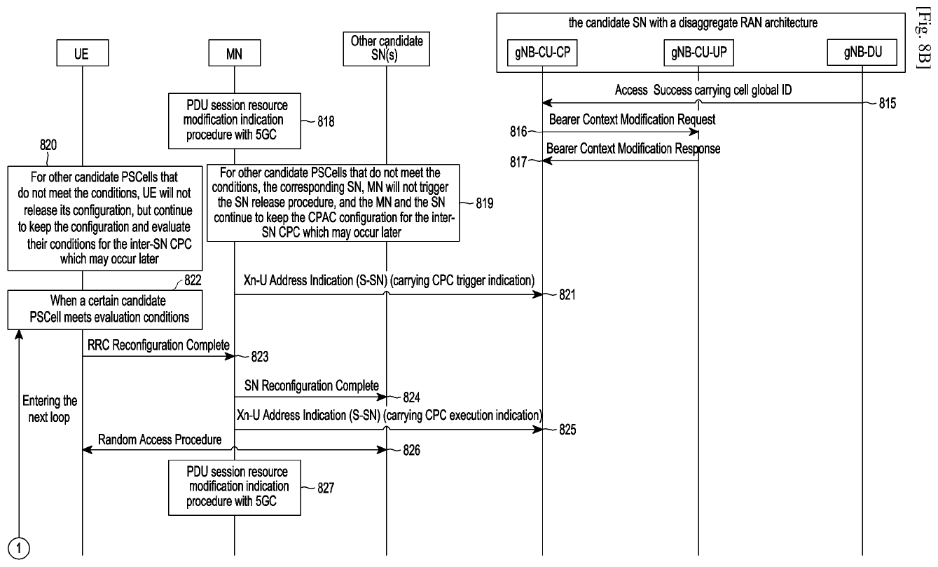

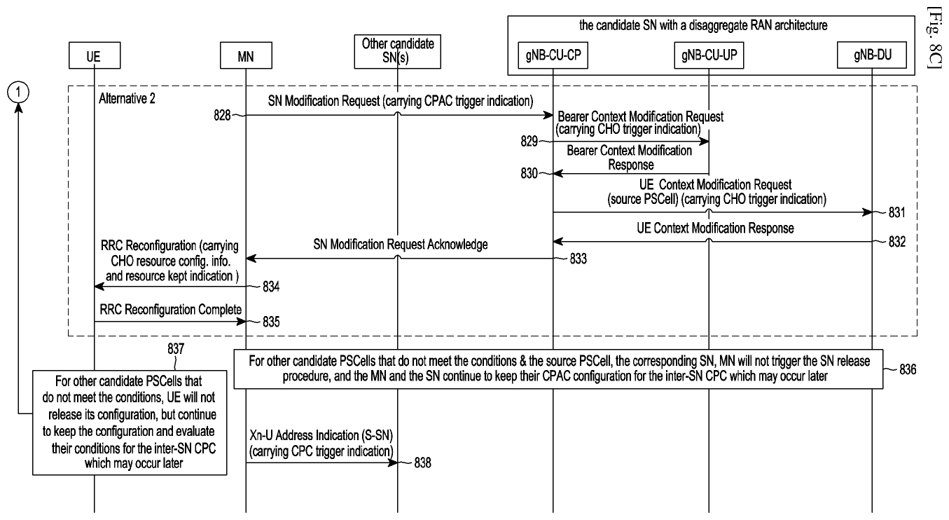

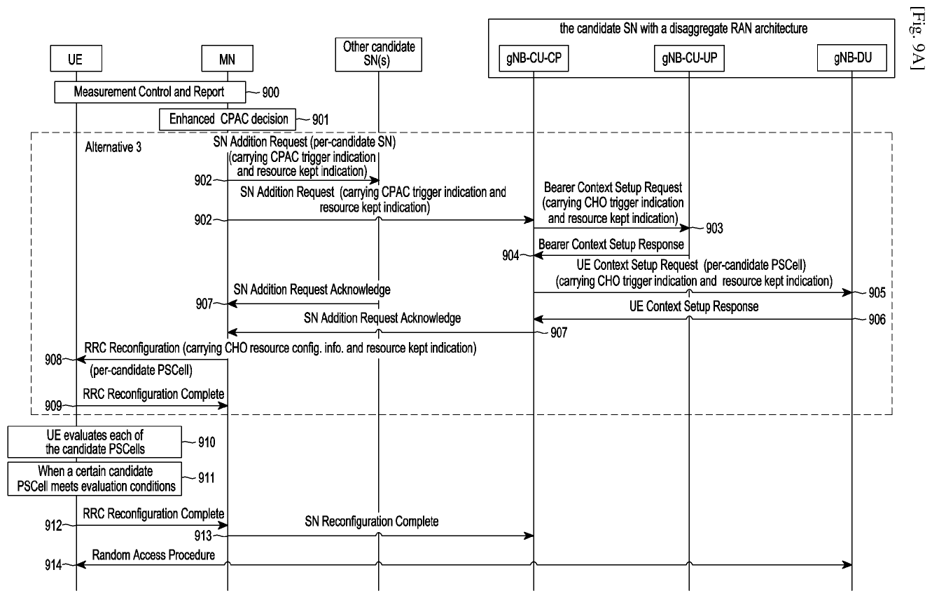

FIG. 6A and FIG. 6B illustrates a diagram of a UE performing enhanced CPC Inter-Distributed Unit (Inter-DU) of a SN in accordance with various embodiments of the present disclosure, wherein FIG. 6A and FIG. 6B illustrate alternative 1 and alternative 2.

In alternative 1, after the UE performs CPC once, the network side and the UE side release the resource of the source PSCell, which will no longer be used as the candidate PSCell for the next CPC. Resources of other unselected candidate PSCells are kept at the network side and the UE side, and the unselected candidate PSCells will be used as candidate PSCells for the next CPC. Only the resource of a candidate PSCell which is selected by the UE and used once will be released after the UE performs the next CPC and accesses other PSCells.

In alternative 2, after the UE performs CPC once, the resource of the source PSCell are reconfigured at the network side and the UE side through signalling, and the source PSCell will be used as the candidate PSCell for the next CPC. Resources of other unselected candidate PSCells are kept at the network side and the UE side, and the unselected candidate PSCells will be used as candidate PSCells for the next CPC. Only the resource of a candidate PSCell which is selected by the UE and used once will be released after the UE performs the next CPC and accesses other PSCells.

Referring to FIG. 6A and FIG. 6B, in step 600, the UE transmits a new radio (NR) measurement report to the master node (MN). In step 601, the MN forwards the NR measurement report to the central unit (gNB-CU) of the secondary node (SN).

In step 602, the gNB-CU of the SN makes the decision of performing enhanced CPC. That is, after the UE performs CPC once, the resources of the unselected candidate PSCells will not be released immediately due to not being selected (except for special cases, the DU and CU initiate a release request or decision for a corresponding candidate PSCell due to some other reasons) but continue to be kept as the candidate PSCells for the next CPC. Only when being selected by the UE and used once, the resource of a candidate PSCell will be release after the UE performs the next CPC and accesses other PSCells. It can be understood that, the resources of the candidate PSCells are kept if not used and will be released after being selected and used once.

In step 603, the gNB-CU of the SN transmits a UE Context Setup Request message to the candidate gNB-DU. In step 604, the candidate gNB-DU transmits a UE Context Setup Response message to the gNB-CU of the SN. The gNB-CU and the candidate gNB-DU perform resource configuration for each candidate PSCell through the UE context Setup procedure.

In step 605, the gNB-CU of the SN transmits a SN Modification Required message to the MN. In step 606, the MN transmits the Radio Resource Control (RRC) Reconfiguration message to the UE, wherein the RRC Reconfiguration message carries the resource configuration information and the evaluation condition measurement configuration (determined by the gNB-CU of the SN) of each candidate PSCell. The RRC Reconfiguration message may also carry at least one indication of:
for example, a conditional RRC reconfiguration kept indication (condRRCReconfigKeptIndicatior=“true”). This indication may indicate based on the UE or based on the candidate PSCell. It is used to control the behaviors of the UE, that is, after the UE performs CPC once, it continues to keep the resources of the unselected candidate PSCells as the candidate PSCells of the next CPC. Only when being selected by the UE and used once, after the UE performs the next CPC to access the other PSCells, the resource of the candidate PSCell will be released. It can be understood that, the resources of the candidate PSCells are kept if not used and will be released after being selected and used once.

In step 607, after obtaining and storing the resources, the UE transmits an UL Information Transfer message carrying an RRC Reconfiguration Complete message to the MN. In step 608, the MN transmits an SN Modification Confirm message carrying the RRC Reconfiguration Complete message to the gNB-CU of the SN.

In steps 609 and 610, the UE measures and evaluates each candidate PSCell. When a certain PSCell meets the evaluation conditions, the UE starts to access a target PSCell and utilize the corresponding resource.

In step 611, the UE successfully accesses the target PSCell and utilizes the corresponding resource. At this time, since the UE obtains the conditional RRC reconfiguration kept indication when being configurated in step 606, the UE performs the behavior of continuing to keep the resources and the evaluation condition measurement configuration of other unselected candidate PSCells.

In step 612, the gNB-DU transmits the cell global ID information of the target PSCell successfully accessed by the UE to the gNB-CU. At this time, since the gNB-CU of the SN decides to perform enhanced CPC, that is, after the UE performs CPC once, the resources of the unselected candidate PSCells will not be released immediately due to not being selected (except for special cases, the DU and CU initiate a release request or decision due to some other reasons) but continue to be kept as the candidate PSCells for the next CPC.

In step 613, after the UE successfully accesses the target PSCell, the UE transmits an UL Information Transfer message carrying an RRC Reconfiguration Complete message to the MN. In step 614, the MN transmits an RRC Transfer message carrying the RRC Reconfiguration Complete message to the gNB-CU of the SN.

In step 615, the gNB-CU of the SN transmits a UE Context Modification Request message carrying a transmission action stop indication to the source gNB-DU. In step 616, the source gNB-DU transmits a UE Context Modification Response message to the gNB-CU. The gNB-CU of the SN indicates the source gNB-DU to stop transmitting downlink data to the UE through the UE context modification procedure.

In steps 617 and 618, at the network side, the gNB-DU and gNB-CU continue to keep the resources of the candidate PSCells not selected by the UE, and the UE side continues to keep the resources and evaluation condition measurement configuration of other unselected candidate PSCells as the candidate PSCells for the next CPC.

In steps 619 to 624 (for alternative 2), after the UE performs CPC once, the resource configured for the source PSCell is released at the UE side, and meanwhile, at the network side, after learning that the UE successfully accesses the target PSCell (step 612), the gNB-CU will also trigger the UE context release procedure to release the resource of the source PSCell later. Therefore, after the UE accesses the target PSCell, if the source PSCell needs to be used as a candidate cell for the next CPC, the gNB-CU should configure resource for the source PSCell as the candidate cell through the UE context modification procedure, and again configure the resource of the source cell to the UE. Similar to the steps 603 to 608 for the configuration of a candidate PSCell, steps 619 to 624 are for the configuration of the source PSCell. On the same principle, in step 622, the RRC Reconfiguration message carries the resource configuration information and the evaluation condition measurement configuration of the source PSCell. The RRC Reconfiguration message may also carry one indication of:
for example, a conditional RRC reconfiguration kept indication (condRRCReconfigKeptIndicatior=“true”). This indication may indicate based on the UE or based on the source PSCell. It is used to control the behaviors of the UE, that is, after the UE performs CPC once, the resources of the unselected source PSCells continue to be kept as the candidate PSCells of the next CPC. Only when being selected by the UE and used once, after the UE performs the next CPC and accesses other PSCells, the resource of the candidate PSCell will be released. It can be understood that, the resources of the candidate PSCells are kept if not used and will be released after being selected and used once.

In step 625, for the next round of CPC, the UE continues to measure and evaluate all candidate PSCells including the unselected candidate PSCells in the last CPC and the source PSCell (configured through steps 619 to 624). For each CPC, the following procedure may proceed to step 609 and start looping.

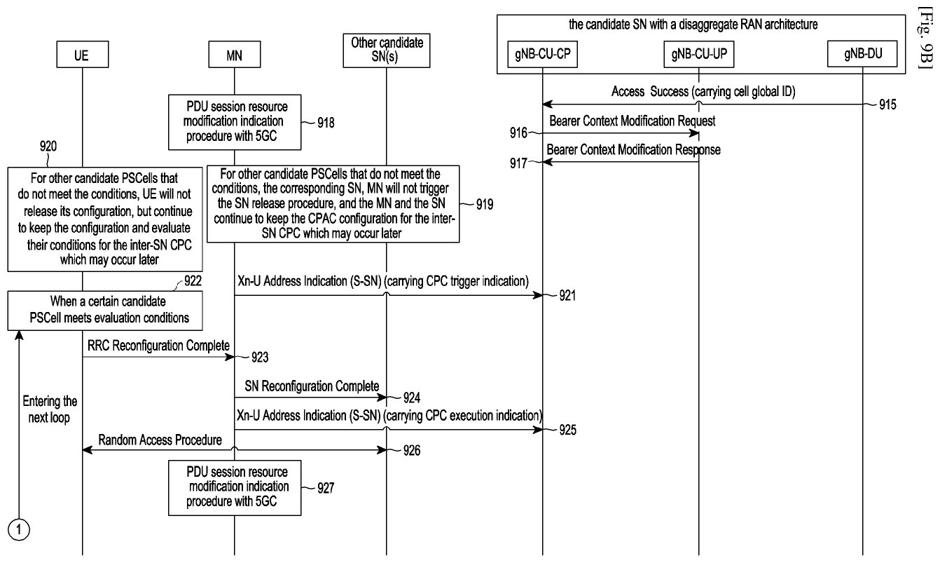

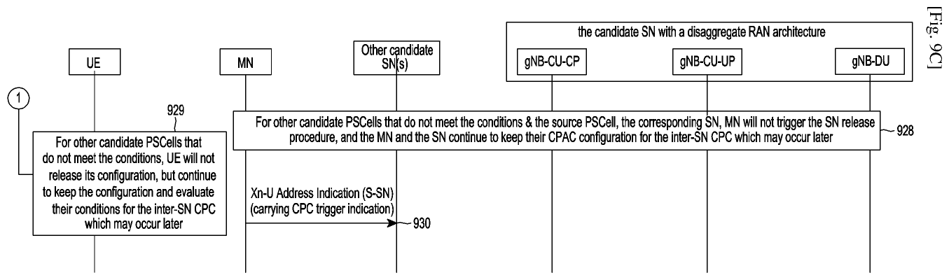

FIG. 7A, FIG. 7B, and FIG. 7C illustrate a diagram of a UE performing enhanced CPC Inter-Distributed Unit (Inter-DU) of a SN in accordance with various embodiments of the present disclosure, wherein FIG. 7A, FIG. 7B, and FIG. 7C illustrate alternative 3 and alternative 4.

In alternative 3, after performing CPC once, the resources of the source PSCell and all the candidate PSCells are kept at the network side and the UE side all the time. That is, after the UE performs CPC once and accesses to a certain candidate PSCell, the source PSCell is then used as the candidate PSCell for the next CPC. Regarding the configuration occasion of the source PSCell, in this solution, it is configured after the UE performs the first CPC.

In alternative 4, after performing CPC once, the resources of the source PSCell and all the candidate PSCells are kept at the network side and the UE side all the time. That is, after the UE performs CPC once and accesses to a certain candidate PSCell, the source PSCell is then used as the candidate PSCell for the next CPC. Regarding the configuration occasion of the source PSCell, in this solution, the source PSCell and the candidate PSCells are configured together when the CPC is initially configured.

Referring to FIG. 7A, FIG. 7B, and FIG. 7C, in step 700, the UE transmits a new radio (NR) measurement report to the master node (MN). In step 701, the MN forwards the NR measurement report to the central unit (gNB-CU) of the secondary node (SN).

In step 702, the gNB-CU of the SN makes the decision of performing enhanced CPC. That is, after the UE performs CPC once, the resources of the unselected candidate PSCells and the source PSCell will not be released immediately (except for special cases, the DU and CU initiate a release request or decision for a corresponding candidate PSCell due to some other reasons) but continue to be kept as the candidate PSCells for the next CPC. That is, the resources of the candidate PSCells and the source PSCell are kept at the gNB-CU and gNB-DU side all the time.

In step 703, the gNB-CU of the SN transmits a UE Context Setup Request message to the candidate gNB-DU. In step 704, the candidate gNB-DU transmits a UE Context Setup Response message to the gNB-CU of the SN. The gNB-CU of the SN and the candidate gNB-DU perform resource configuration for each candidate PSCell through the UE context Setup procedure. Meanwhile, for the source PSCell, upon the UE preforms CPC once and accesses to one of the candidate PSCells, it may need to configure the source PSCells as the candidate PSCell for the next CPC. Thus, the gNB-CU configures resource for the source PSCell as the candidate PSCell through the UE context modification procedure, the resource of the source PSCell is then configured to the UE along with the resource of the candidate PSCell. So the UE Context Setup Request message and the UE Context Modification Request message may carry at least one indication of: —for example, CHO resource or context kept indication (CHO resource/context Kept Indicator=“true”). This indication indicates based on the UE or based on the candidate PSCell and the source PSCell. It is used to control the behaviors of the DU, that is, after the UE performs CPC once, the resources of the unselected candidate PSCells and the source PSCell continue to be kept as the candidate PSCells of the next CPC. That is, the resources of the candidate PSCells and the source PSCell are kept at the gNB-CU and gNB-DU side all the time.

In step 705, the gNB-CU of the SN transmits a SN Modification Required message carrying a Radio Resource Control (RRC) Reconfiguration message to the MN. In step 706, the MN transmits the RRC Reconfiguration message to the UE, wherein the RRC Reconfiguration message carries the resource configuration information and the evaluation condition measurement configuration (determined by the gNB-CU of the SN) of each candidate PSCell and the source PSCell (i.e., the PSCell currently serving the UE). The RRC Reconfiguration message may also carry at least one indication of:
for example, a conditional RRC reconfiguration kept indication (condRRCReconfigKeptIndicatior=“true”). This indication may indicate based on the UE or based on the candidate PSCell and the source PSCell. It is used to control the behaviors of the UE, that is, after the UE performs CPC once, the resources of the unselected candidate PSCells and the resource of the source PSCell continue to be kept as the candidate PSCells of the next CPC. That is, the resources and the evaluation condition measurement configuration of the candidate PSCells and the source PSCell are kept at the UE side all the time, unless the network side initiates the release.

In step 707, after obtaining and storing the configuration, the UE transmits an UL Information Transfer message carrying an RRC Reconfiguration Complete message to the MN. In step 708, the MN transmits an SN Modification Confirm message carrying the RRC Reconfiguration Complete message to the gNB-CU of the SN.

In steps 709 and 710, the UE measures and evaluates each candidate PSCell. When a certain PSCell meets the evaluation conditions, the UE starts to access a target PSCell and utilize the corresponding resource.

In step 711, the UE successfully accesses the target PSCell and utilizes the corresponding resource. At this time, since the UE obtains the conditional RRC reconfiguration kept indication when being configurated in step 706, the UE performs the behavior of continuing to keep the resources and the evaluation condition measurement configuration of other unselected candidate PSCells and the source PSCell.

In step 712, the gNB-DU transmits the cell global ID information of the target PSCell successfully accessed by the UE to the gNB-CU. At this time, since the gNB-CU of the SN decides to perform enhanced CPC, that is, after the UE performs CPC once, the resources of the unselected candidate PSCells and the source PSCell will not be released immediately (except for special cases, the DU and CU initiate a release request or decision for a corresponding candidate PSCell due to some other reasons) but continue to be kept as the candidate PSCells for the next CPC. That is, the resources of the candidate PSCells and the source PSCell are kept at the gNB-CU and gNB-DU side all the time.

In step 713, after the UE successfully accesses the target PSCell, the UE transmits an UL Information Transfer message carrying an RRC Reconfiguration Complete message to the MN. In step 714, the MN transmits an RRC Transfer message carrying the RRC Reconfiguration Complete message to the gNB-CU of the SN.

In step 715, the gNB-CU of the SN transmits a UE Context Modification Request message carrying a transmission action stop indication to the source gNB-DU. In step 716, the source gNB-DU transmits a UE Context Modification Response message to the gNB-CU. The gNB-CU of the SN indicates the source gNB-DU to stop transmitting downlink data to the UE through the UE context modification procedure.

In steps 717 to 722 (for alternative 3), if the source PSCell and candidate PSCells are not pre-configured together in steps 703 to 708, the resource configuration for the source PSCell can be considered after the UE performs CPC for the first time. Therefore, after the UE successfully accesses the target PSCell, the gNB-CU configures resource for the source PSCell as the candidate PSCell through the UE context modification procedure, and then again configure the resource of the source PSCell to the UE. Similar to the steps 703 to 608 for the configuration of a candidate PSCell, steps 717 to 722 are for the configuration of the source PSCell. On the same principle, the UE Context Modification Request message may carry one indication of:
for example, CHO resource or context kept indication (CHO resource/context Kept Indicator=“true”). This indication indicates based on the source PSCell. It is used to control the behaviors of the DU, that is, after the UE performs CPC once, the resource of the source PSCell continues to be kept as the candidate PSCell of the next CPC. That is, the resource of the source PSCell is kept at the gNB-CU and gNB-DU side all the time.

In step 720, the RRC Reconfiguration message carries the resource configuration information and the evaluation condition measurement configuration of the source PSCell. The RRC Reconfiguration message may also carry at least one indication of:
for example, a conditional RRC reconfiguration kept indication (condRRCReconfigKeptIndicatior=“true”). This indication may indicate based on the UE or based on the source PSCell. It is used to control the behaviors of the UE, that is, after the UE performs CPC once, the resource of the source PSCell continue to be kept as the candidate PSCell of the next CPC. That is, the resources of the candidate PSCell and the source PSCell are kept at the UE side all the time, unless the network side initiates the release.

In steps 723 and 724, at the network side, the gNB-DU and gNB-CU continue to keep the resources of the candidate PSCells not selected by the UE and the source PSCell, and the UE side continues to keep the resources of other unselected candidate PSCells and the source PSCell and evaluation condition measurement configuration as the preparation for the next CPC.

In step 725, for the next round of CPC, the UE continues to measure and evaluate all candidate PSCells including the unselected candidate PSCells in the last CPC and the source PSCell (configured through steps 703 to 708, or steps 717 to 723).

In steps 726 to 733, for performing each CPC, similar processes are performed on both the UE side and the network side. After UE evaluates the conditions, selects a target PSCell meeting the conditions and successfully accesses the PSCell, other candidate PSCells and the source PSCell serve as the candidate cells for the next CPC, and their resources are kept on the UE side and the network side all the time (unless for special cases, the gNB-DU or the gNB-CU initiates a release request or decision for a corresponding candidate PSCell due to some other reasons). Then, the procedure may proceed to step 725 and start looping.

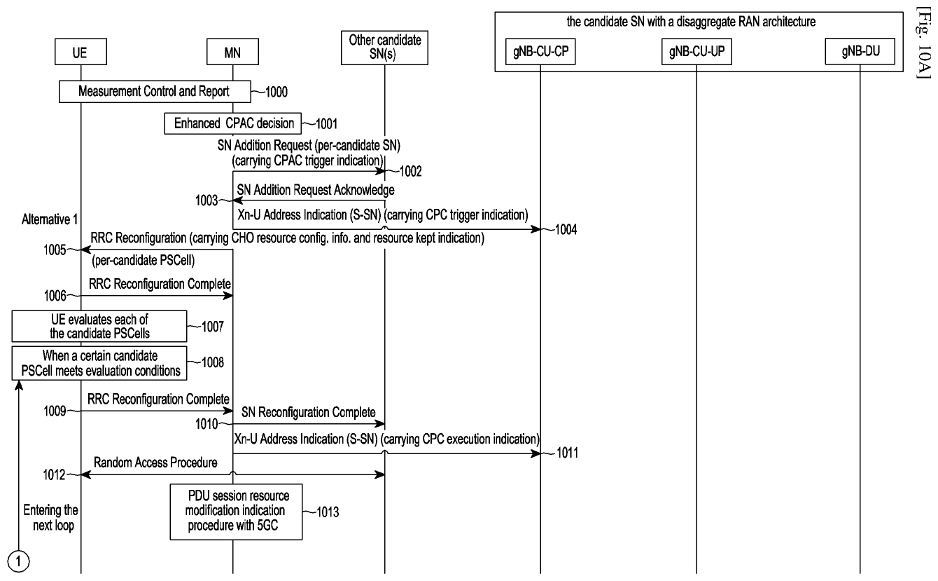

FIG. 8A, FIG. 8B, and FIG. 8C illustrate a diagram of a UE performing enhanced conditional cell addition (CPA) and enhanced CPC Inter-SN in accordance with various embodiments of the present disclosure, wherein FIG. 8A, FIG. 8B, and FIG. 8C illustrate alternative 1 and alternative 2.

In alternative 1, after the UE performs CPA or CPC once, the network side and the UE side release the resource of the source PSCell, which will no longer be used as the candidate PSCell for the next CPC. Resources of other unselected candidate PSCells are kept at the network side and the UE side, and the unselected candidate PSCells will be used as candidate PSCells for the next CPC. Only the resource of a candidate PSCell which is selected by the UE and used once will be released after the UE performs the next CPC and accesses other PSCells.

In alternative 2, after the UE performs CPA or CPC once, the resource of the source PSCell are reconfigured at the network side and the UE side through signalling, and the source PSCell will be used as the candidate PSCell for the next CPC. Resources of other unselected candidate PSCells are kept at the network side and the UE side, and the unselected candidate PSCells will be used as candidate PSCells for the next CPC. Only the resource of a candidate PSCell which is selected by the UE and used once will be released after the UE performs the next CPC and accesses other PSCells.

Referring to FIG. 8A, FIG. 8B, and FIG. 8C, in step 800, the UE performs NR measurement configuration and transmits the measurement report to the MN.

In step 801, the MN makes the decision of performing enhanced CPAC (CPA and/or CPC). That is, after the UE performs CPAC once, the resources of the unselected candidate PSCells will not be released immediately due to not being selected (except for special cases, the network side initiates a release request or decision for a corresponding candidate PSCell due to some other reasons) but continue to be kept as the candidate PSCells for the next CPC. Only when being selected by the UE and used once, the resource of a candidate PSCell will be release after the UE performs the next CPC and accesses other PSCells. It can be understood that, the resources of the candidate PSCells are kept if not use and will be released after being selected and used once.

In step 802, the MN transmits a SN Addition Request message to the candidate SNs. The MN initiates the SN addition request procedure, and for each candidate SN corresponding to all or part of the candidate PSCells provided in the UE measurement report, prepares the resources of the candidate PSCells for the UE, and carries the CPAC trigger indication information.

If the candidate SN is a disaggregate architecture of CU-CP, CU-UP and gNB-DU, in step 803, the gNB-CU-CP of the SN transmits a Bearer Context Setup Request message to the gNB-CU-UP, and in step 804, the gNB-CU-UP of the SN transmits a Bearer Context Setup Response message to the gNB-CU-CP. The gNB-CU-CP of the SN initiates the bearer context setup procedure, prepares the corresponding user plane resources for the UE, and carries the CPAC trigger indication information.

In step 805, the gNB-CU-CP of the candidate SN transmits a UE Context Setup Request message to the gNB-DU to which the candidate PSCell belongs, and in step 806, the gNB-DU transmits a UE Context Setup Response message to the gNB-CU-CP of the candidate SN. The gNB-CU-CP of the candidate SN and the belonging gNB-DU perform resource configuration for each candidate PSCell to which it belongs through the UE context Setup procedure.

In step 807, after the SN has prepared the resources of the candidate PSCells, in response to the SN Addition Request message, the SN transmits an SN Addition Request Acknowledge message to the MN, and carries the resources of the relevant candidate PSCells.

In step 808, the MN transmits the RRC Reconfiguration message to the UE. The gNB-CU of the SN configures the UE through the MN, wherein the RRC Reconfiguration message carries the resource configuration information and the evaluation condition measurement configuration (determined by the MN) of each candidate PSCell. The RRC Reconfiguration message may also carry at least one indication of:
for example, a conditional RRC reconfiguration kept indication (condRRCReconfigKeptIndicatior=“true”). This indication may indicate based on the UE or based on the candidate PSCell. It is used to control the behaviors of the UE, that is, after the UE performs CPAC once, it continues to keep the resources of the unselected candidate PSCells as the candidate PSCells of the next CPC. Only when being selected by the UE and used once, after the UE performs the next CPC and accesses other PSCells, the resource of the candidate PSCell will be released. It can be understood that, the resources of the candidate PSCells are kept if not used and will be released after being selected and used once. Otherwise, it is kept at the UE side all the time, unless the network side initiates the release.

In step 809, after obtaining and storing the configuration, the UE transmits an RRC Reconfiguration Complete message to the MN.

In steps 810 and 811, the UE measures and evaluates each candidate PSCell. When a certain PSCell meets the evaluation conditions, the UE transmits the RRC Reconfiguration Complete message to inform the MN, and then starts to access the target PSCell and applies the corresponding configuration.

In steps 812 and 813, when a certain PSCell meets the evaluation conditions, the UE transmits an RRC Reconfiguration Complete message to the MN, and the MN transmits a SN Reconfiguration Complete message to the selected target SN.

In step 814, the UE successfully accesses the target PSCell and utilizes the corresponding resource. At this time, since the UE obtains the conditional RRC reconfiguration kept indication when being configurated in step 808, the UE performs the behavior of continuing to keep the resources and the evaluation condition measurement configuration of other unselected candidate PSCells.

In step 815, the gNB-DU transmits the cell global ID information of the target PSCell successfully accessed by the UE to the gNB-CU. At this time, since the MN makes the decision of performing enhanced CPAC, that is, after the UE performs CPAC once, the resources of the unselected candidate PSCells will not be released immediately due to not being selected (except for special cases, the network side initiates a release request or decision for a corresponding candidate PSCell due to some other reasons) but continue to be kept as the candidate PSCells for the next CPC. Only when being selected by the UE and used once, the resource of a candidate PSCell will be released after the UE performs the next CPC and accesses other PSCells. It can be understood that, the resources of the candidate PSCells are kept if not used and will be released after being selected and used once.

In step 816, the gNB-CU-CP transmits a Bearer Context Modification Request message to the gNB-CU-UP, and in step 817, the gNB-CU-UP transmits a Bearer Context Modification Response message to the gNB-CU-CP. The gNB-CU-CP transmits the security configuration information and the transport network layer address and tunnel endpoint ID information regarding to transmission of the downlink data to the gNB-CU-UP through the bearer context modification procedure.

In step 818, the MN may transmit the transport network layer address and tunnel endpoint ID information regarding to the reception of downlink data to the 5GC.

In steps 819 and 820, at the network side, the MN and the candidate SNs continue to keep the resources of the candidate PSCells not selected by the UE, and the UE side continues to keep the resources of other unselected candidate PSCells and evaluation condition measurement configuration, as the candidate PSCells for the next CPC.

In step 821, for the next round of CPC, the MN transmits an Xn-U address indication to the source SN, the indication carries information such as a CPC trigger indication and a data forwarding address. The source SN may perform the process of an early data forwarding.

In step 822, for the next round of CPC, the UE continues to measure and evaluate the unselected candidate PSCells in the last CPAC.

In steps 823 to 827, in the following procedure, for each CPC, similar processes are performed on both the UE side and the network side. After UE evaluates the conditions, selects a target PSCell meeting the conditions and successfully accesses the target PSCell, other unselected candidate PSCells are used as the candidate cells for the next CPC, and the UE side and the network side keep the resources corresponding to all the candidate PSCells all the time (unless for special cases, the network side (the gNB-DU or the gNB-CU) initiates a release request or decision for a corresponding candidate PSCell due to some other reasons).

In steps 825 to 835 (for alternative 2), after the UE performs CPAC once, the resource configured for the source PSCell is released at the UE side, and meanwhile, at the network side, after learning that the UE successfully accesses the target PSCell, the MN will also trigger the SN release procedure and the UE context release procedure to release the resource of the source PSCell later. Therefore, after the UE accesses the target PSCell, if the source PSCell needs to be used as a candidate cell for the next CPC, the MN may trigger SN to prepare resource for the source PSCell as the candidate cell through the SN modification request procedure, and the SN then configures resource for the source PSCell as the candidate cell through the bearer context modification procedure and the UE context modification procedure, and again configures the resource of the source PScell to the UE. In step 734, the RRC Reconfiguration message carries the resource configuration information and the evaluation condition measurement configuration of the source PSCell. The RRC Reconfiguration message may also carry at least one indication of:
for example, a conditional RRC reconfiguration kept indication (condRRCReconfigKeptIndicatior=“true”). This indication may indicate based on the UE or based on the source PSCell. It is used to control the behaviors of the UE, that is, after the UE performs CPAC once, the resource of the unselected source PSCell continue to be kept as the preparation for the next CPC. Only when being selected by the UE and used once, after the UE performs the next CPC to access the other PSCells, the resource of the source PSCell will be released. It can be understood that, the resource of the source PSCell is kept if not used and will be released after being selected and used once.

In steps 836 and 837, for the next round of CPC, the UE continues to measure and evaluate all candidate PSCells including the unselected candidate PSCells in the last CPC and the source PSCell (configured through steps 828 to 835). In the following procedure, for each CPC, the following process may proceed to step 822 and start looping.

In step 838, for the next round of CPC, the MN transmits an Xn-U address indication to the source SN, the indication carries information such as a CPC trigger indication and a data forwarding address.

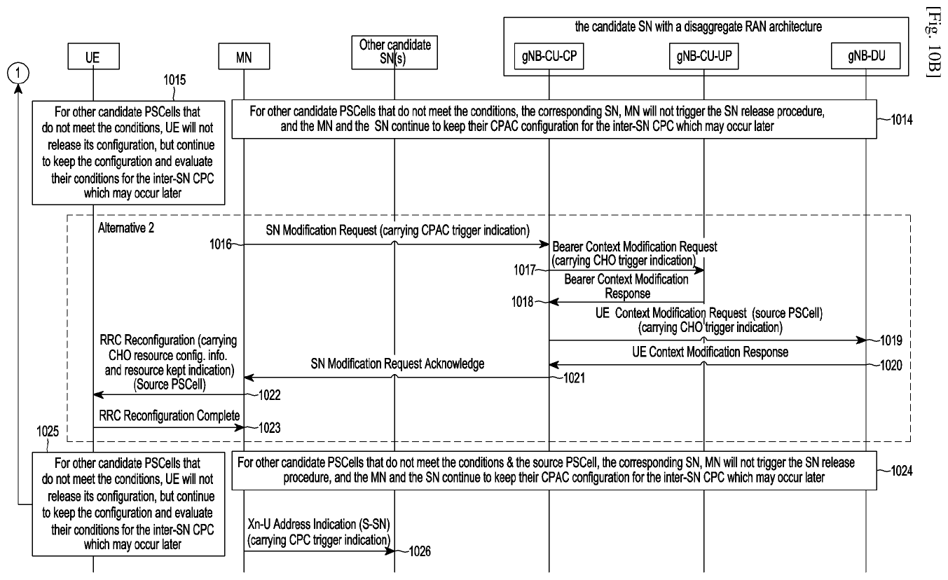

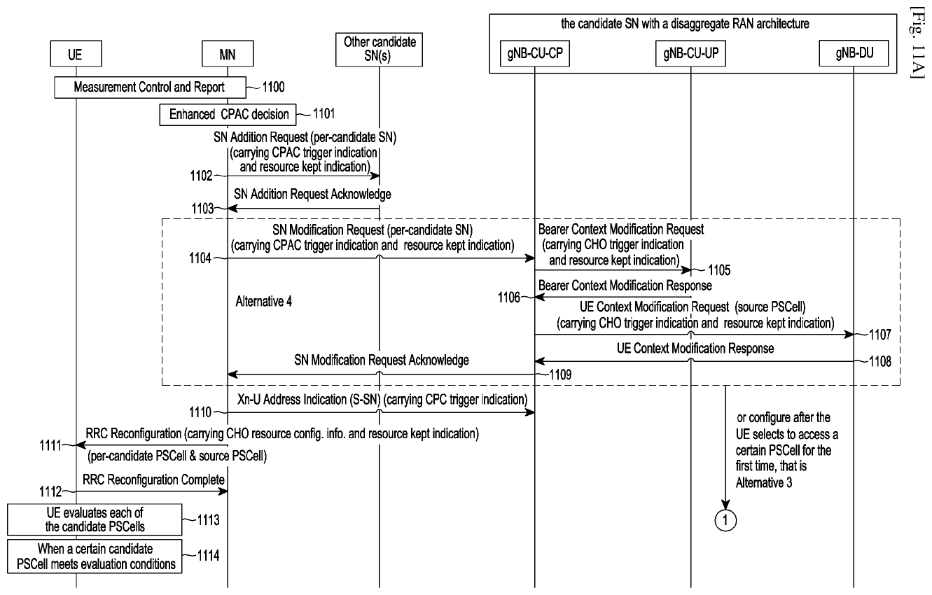

FIG. 9A, FIG. 9B, and FIG. 9C illustrate a diagram of a UE performing enhanced CPA and enhanced CPC Inter-SN in accordance with various embodiments of the present disclosure, wherein FIG. 9A, FIG. 9B, and FIG. 9C illustrates alternative 3.

In alternative 3, after performing CPA or CPC once, the configuration of the source PSCell and all the candidate PSCells are kept at the network side and the UE side all the time. That is, after the UE performs CPAC (CPA and/or CPC) once and accesses to a certain candidate PSCell, the resources of the unselected candidate PSCells and the source PSCell are kept as the candidate PSCell for the next CPC.

Referring to FIG. 9A, FIG. 9B, and FIG. 9C, in step 900, the UE performs NR measurement configuration and transmits the measurement report to the MN.

In step 901, the MN decides to perform enhanced CPAC (CPA and/or CPC). That is, after the UE performs CPAC once, the resources of the unselected candidate PSCells will not be released immediately due to not being selected (except for special cases, the network side initiates a release request or decision for a corresponding candidate PSCell due to some other reasons) but continue to be kept as the candidate PSCells for the next CPC. Even if the resource of a candidate PSCell is selected and utilized by the UE, after the UE performs the next CPC and accesses to other candidate PSCells, the resource of the candidate PSCell is still kept, that is, the source PSCell is used as the candidate PSCell for the next CPC. It can be understood that, the resources of the candidate PSCells and the source PSCell are kept at the network side (gNB-CU and gNB-DU, or gNB-CU-CP, gNB-CU-UP and gNB-DU) all the time.

In step 902, the MN transmits a SN Addition Request message to the candidate SNs. The MN initiates the SN addition request procedure, and for each candidate SN corresponding to all or part of the candidate PSCells provided in the UE measurement report, prepares the resources of the candidate PSCells for the UE. Wherein, the SN Addition Request message may carry at least one indication of:
for example, CHO resource or context kept indication (CHO resource/context Kept Indicator=“true”). This indication indicates based on the candidate PSCell or based on the UE. It is used to control the behaviors of the candidate SN, that is, after the UE performs CPAC once, the resources of the unselected candidate PSCells and the source PSCell continue to be kept as the candidate PSCells of the next CPC. That is, the resources of the candidate PSCells and the source PSCell are kept at the SN side all the time.

If the candidate SN is a disaggregate architecture of CU-CP, CU-UP and gNB-DU, in step 903, the gNB-CU-CP of the SN transmits a Bearer Context Setup Request message to the gNB-CU-UP, and in step 904, the gNB-CU-UP of the SN transmits a Bearer Context Setup Response message to the gNB-CU-CP. The Bearer Context Setup Request message may carry one indication of:
for example, CHO resource or context kept indication (CHO resource/context Kept Indicator=“true”). This indication indicates based on the UE. It is used to control the behaviors of the gNB-CU-UP of the candidate SN, that is, after the UE performs CPAC once, the resources of the unselected candidate PSCells and the source PSCell continue to be kept as the preparation for the next CPC. That is, the resource configuration of the candidate PSCells and the source PSCell are kept at the gNB-CU-UP of the SN side all the time.

In step 905, the gNB-CU-CP of the candidate SN transmits a UE Context Setup Request message to the gNB-DU to which the candidate PSCell belongs, and in step 906, the gNB-DU of the SN transmits a UE Context Setup Response message to the gNB-CU-CP. The gNB-CU-CP of the candidate SN and the belonging gNB-DU perform resource configuration for each candidate PSCell to which it belongs through the UE context setup procedure. So, the UE Context Setup Request message may carry at least one indication of:
for example, CHO resource or context kept indication (CHO resource/context Kept Indicator=“true”). This indication indicates based on the candidate PSCells. It is used to control the behaviors of the DU, that is, after the UE performs CPAC once, the resources of the unselected candidate PSCells and the source PSCell continue to be kept as the candidate PSCells of the next CPC. That is, the configuration of the candidate PSCells and the source PSCell are kept at the gNB-CU-CP of the SN side all the time.

In step 907, after the SN has prepared the resources of the candidate PSCells, in response to the SN Addition Request message, the SN transmits an SN Addition Request Acknowledge message to the MN, and carries the resources of the relevant candidate PSCells.

In step 908, the MN transmits the RRC Reconfiguration message to the UE. The gNB-CU of the SN configures the UE through the MN, wherein the RRC Reconfiguration message carries the resource configuration information and the evaluation condition measurement configuration (determined by the MN) of each candidate PSCell. The RRC Reconfiguration message may also carry at least one indication of:
for example, a conditional RRC reconfiguration kept indication (condRRCReconfigKeptIndicatior=“true”). This indication may indicate based on the UE or based on the candidate PSCell. It is used to control the behaviors of the UE, that is, after the UE performs CPAC once, the resources of the unselected candidate PSCells and the source PSCell continue to be kept as the candidate PSCells of the next CPC. That is, the resources and the evaluation condition measurement configuration of the candidate PSCells and the source PSCell are kept at the UE side all the time, unless the network side initiates the release.

In step 909, after obtaining and storing the resources, the UE transmits an RRC Reconfiguration Complete message to the MN.

In steps 910 and 911, the UE measures and evaluates each candidate PSCell. When a certain PSCell meets the evaluation conditions, the UE transmits the RRC Reconfiguration Complete message to inform the MN, and then starts to access the target PSCell and applies the corresponding configuration.

In steps 912 and 913, when a certain PSCell meets the evaluation conditions, the UE transmits an RRC Reconfiguration Complete message to the MN, and the MN transmits a SN Reconfiguration Complete message to the selected target SN.

In step 914, the UE successfully accesses the target PSCell and utilizes the corresponding resource. At this time, since the UE obtains the conditional RRC reconfiguration kept indication when being configurated in step 908, the UE performs the behavior of continuing to keep the resources and the evaluation condition measurement configuration of other unselected candidate PSCells and the source PSCell (the PSCell currently serving the UE).

In step 915, the gNB-DU transmits the cell global ID information of the target PSCell successfully accessed by the UE to the gNB-CU. At this time, since the MN makes the decision to perform enhanced CPAC, that is, after the UE performs CPAC once, the resources of the unselected candidate PSCells and the source PSCell (the PSCell currently serving the UE) will not be released immediately (except for special cases, the network side initiates a release request or decision for a corresponding candidate PSCell due to some other reasons) but continue to be kept as the candidate PSCells for the next CPC. That is, the resources of the candidate PSCells and the source PSCell are kept at the network side (gNB-CU and gNB-DU, or gNB-CU-CP, gNB-CU-UP and gNB-DU) all the time.

In step 916, the gNB-CU-CP transmits a Bearer Context Modification Request message to the gNB-CU-UP, and in step 917, the gNB-CU-UP transmits a Bearer Context Modification Response message to the gNB-CU-CP. The gNB-CU-CP transmits the security configuration information and the transport network layer address and tunnel endpoint ID information regarding to transmission of the downlink data to the gNB-CU-UP through the bearer context modification procedure.

In step 918, the MN may transmit the transport network layer address and tunnel endpoint ID information regarding to the reception of downlink data to the 5GC.

In steps 919 and 920, at the network side, the MN and the candidate SNs continue to keep the resources of the candidate PSCells not selected by the UE and the source PSCell (the PSCell currently serving the UE), and the UE side continues to keep the resources and evaluation condition measurement configuration of other unselected candidate PSCells and the source PSCell (the PSCell currently serving the UE), as the preparation for the next CPC.

In step 921, for the next round of CPC, the MN transmits an Xn-U address indication to the source SN, where the indication carries information such as a CPC trigger indication and a data forwarding address. The source SN may perform the process of an early data forwarding.

In step 922, for the next round of CPC, the UE continues to measure and evaluate all the candidate PSCells, including the unselected candidate PSCells in the last CPAC and the source PSCell.

In steps 923 to 930, in the following procedure, for each CPC, similar processes are performed on both the UE side and the network side. After UE evaluates the conditions, selects a target PSCell meeting the conditions and successfully accesses the target PSCell, other candidate PSCells and the source PSCell serve as the candidate cells for the next CPC, and the UE side and the network side keep the resources all the time (unless for special cases, the network side (the gNB-DU or the gNB-CU) initiates a release request or decision for a corresponding candidate PSCell due to some other reasons). Then, the procedure may proceed to step 922 and start looping.

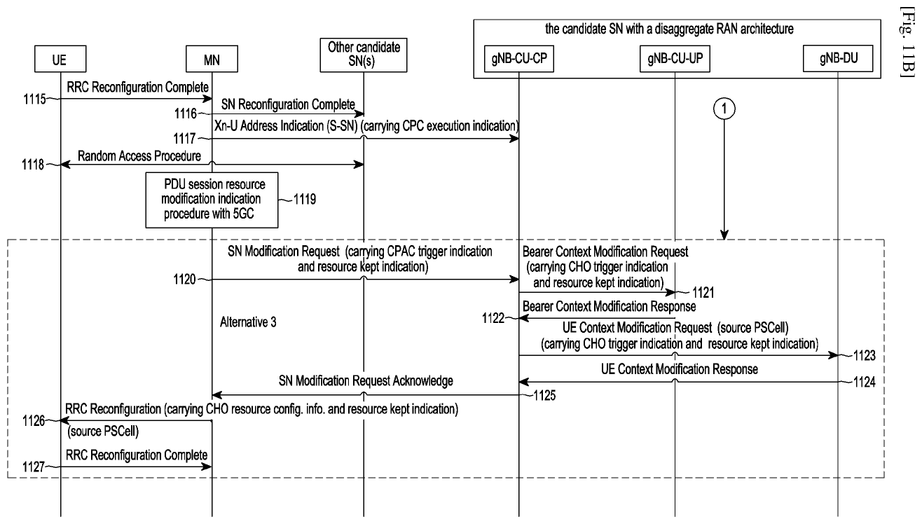

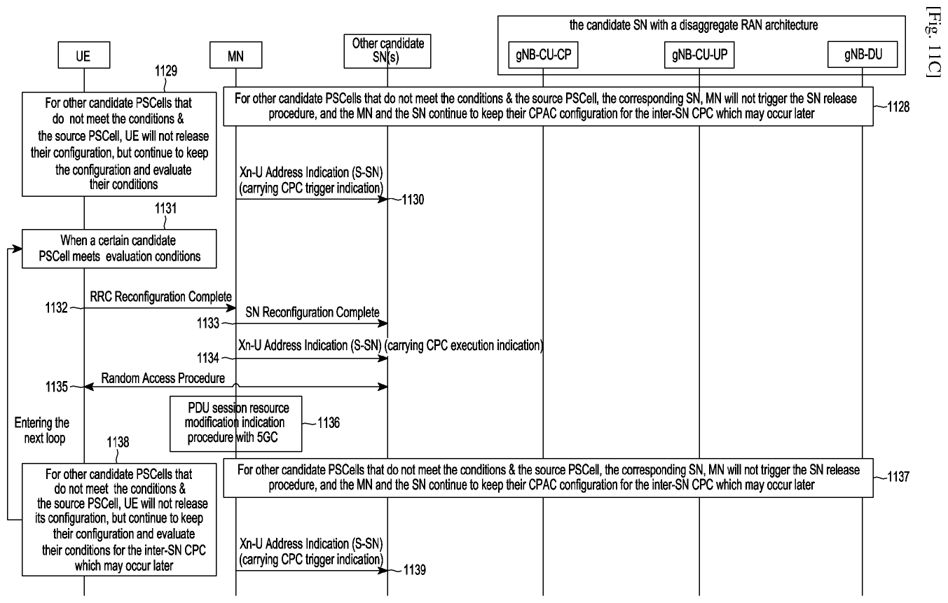

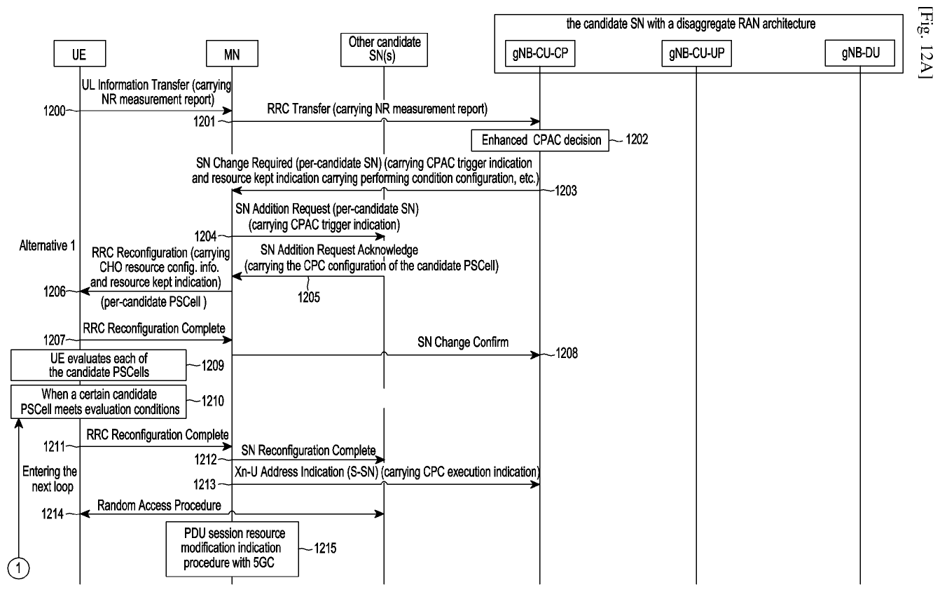

FIG. 10A and FIG. 10B illustrate a diagram of a UE performing enhanced CPC initiated by a master node (MN) Inter-SN in accordance with various embodiments of the present disclosure, wherein FIG. 10A and FIG. 10B illustrate alternative 1 and alternative 2

In alternative 1, after the UE performs CPC once, the network side and the UE side release the resource of the source PSCell, which will no longer be used as the candidate PSCell for the next CPC. Resources of unselected candidate PSCells are kept at the network side and the UE side, and the unselected candidate PSCells will be used as candidate PSCells for the next CPC. Only the resource of a candidate PSCell which is selected by the UE and used once will be released after the UE performs the next CPC and accesses other PSCells.

In alternative 2, after the UE performs CPC once, the resource of the source PSCell are reconfigured at the network side and the UE side through signalling, and the source PSCell will be used as the candidate PSCell for the next CPC. The resources of other unselected candidate PSCells are kept at the network side and the UE side, and the unselected candidate PSCells will be used as candidate PSCells for the next CPC. Only the resource of a candidate PSCell which is selected by the UE and used once will be released after the UE performs the next CPC and accesses other PSCells.

Referring to FIG. 10A and FIG. 10B, in step 1000, the UE performs NR measurement configuration and transmits the measurement report to the MN.

In step 1001, the MN makes the decision of performing enhanced CPAC (CPA and/or CPC). That is, after the UE performs CPC once, the resources of the unselected candidate PSCells will not be released immediately due to not being selected (except for special cases, the network side initiates a release request or decision for a corresponding candidate PSCell due to some other reasons) but continue to be kept as the preparation for the next CPC. Only when being selected by the UE and used once, the resource of a candidate PSCell will be release after the UE performs the next CPC and accesses other PSCells. It can be understood that, the resources of the candidate PSCells are kept if not used and will be released after being selected and used once.

In step 1002, the MN transmits a SN Addition Request message to the candidate SNs. The MN initiates the SN addition request procedure, and for each candidate SN corresponding to all or part of the candidate PSCells provided in the UE measurement report, prepares the resources of the candidate PSCells for the UE, and carries the CPAC trigger indication information. If the candidate SN is a disaggregate architecture of CU-CP, CU-UP and gNB-DU, then prepares the corresponding resources and carries a CPAC trigger indication information through a bearer context setup procedure initiated between the gNB-CU-UP and the gNB-CU-CP of the SN. Resource configuration for each candidate PSCell belonging to the gNB-CU-CP is performed through the UE context setup procedure initiated between the gNB-CU-CP of the candidate SN and the belonging gNB-DU.

In step 1003, after the SN has prepared the resources of the candidate PSCells, in response to the SN Addition Request message, the SN transmits an SN Addition Request Acknowledge message to the MN, and carries the resources of the relevant candidate PSCells.

In step 1004, the MN transmits an Xn-U address indication to the source SN, where the indication carries information such as a CPC trigger indication and a data forwarding address. The source SN may perform the process of an early data forwarding.

In step 1005, the MN transmits the RRC Reconfiguration message to the UE. The gNB-CU of the SN configures the UE through the MN, wherein the RRC Reconfiguration message carries the resource configuration information and the evaluation condition measurement configuration (determined by the MN) of each candidate PSCell. The RRC Reconfiguration message may also carry at least one indication of:
for example, a conditional RRC reconfiguration kept indication (condRRCReconfigKeptIndicatior=“true”). This indication may indicate based on the UE or based on the candidate PSCells. It is used to control the behaviors of the UE, that is, after the UE performs CPC once, it continues to keep the resources of the unselected candidate PSCells as the candidate PSCells of the next CPC. Only when being selected by the UE and used once, after the UE performs the next CPC and accesses other PSCells, the resource of the candidate PSCell will be released. It can be understood that, the resources of the candidate PSCells are kept if not used and will be released after being selected and used once. Otherwise, the resources of the candidate PSCells are kept at the UE side all the time, unless the network side initiates the release.
In step 1006, after obtaining and storing the resources, the UE transmits an RRC Reconfiguration Complete message to the MN.

In steps 1007 and 1008, the UE measures and evaluates each candidate PSCell. When a certain PSCell meets the evaluation conditions, the UE transmits the RRC Reconfiguration Complete message to the MN, and then starts to access the target PSCell and applies the corresponding configuration.

In steps 1009 and 1010, when a certain PSCell meets the evaluation conditions, the UE transmits an RRC Reconfiguration Complete message to the MN, and the MN transmits a SN Reconfiguration Complete message to the selected target SN. Since the MN makes the decision of performing enhanced CPAC, that is, after the UE performs CPC once, the resources of the unselected candidate PSCells will not be released immediately due to not being selected (except for special cases, the network side initiates a release request or decision for a corresponding candidate PSCell due to some other reasons) but continue to be kept as the candidate PSCells for the next CPC. Only when being selected by the UE and used once, the resource of a candidate PSCell will be release after the UE performs the next CPC and accesses other PSCells. It can be understood that, the resources of the candidate PSCells are kept if not used and will be released after being selected and used once.

In step 1011, the MN transmits an Xn-U address indication to the source SN, where the indication carries information such as a CPC trigger indication and a data forwarding address. The source SN may perform the process of an early data forwarding.

In step 1012, the UE successfully accesses the target PSCell and utilizes the corresponding resource. At this time, since the UE obtains the conditional RRC reconfiguration kept indication when being configurated in step 1005, the UE performs the behavior of continuing to keep the resources and the evaluation condition measurement configuration of other unselected candidate PSCells.

In step 1013, the MN may transmit the transport network layer address and tunnel endpoint ID information regarding to the reception of downlink data to the 5GC.

In steps 1014 and 1015, at the network side, the MN and the candidate SNs continue to keep the resources of the candidate PSCells not selected by the UE, and the UE side continues to keep the resources and evaluation condition measurement configuration of other unselected candidate PSCells, as the candidate PSCells for the next CPC.

In steps 1016 to 1023 (for alternative 2), after the UE performs CPC once, the resource configured for the source PSCell is released at the UE side, and at this time, at the network side, after learning that the UE successfully accesses the target PSCell, the MN will also trigger the SN release procedure and the UE context release procedure to release the resource of the source PSCell later. Therefore, after the UE accesses the target PSCell, if the source PSCell needs to be used as a candidate cell for the next CPC, the MN may trigger SN to prepare resource for the source PSCell as the candidate cell through the SN modification request procedure, and the SN then configures resource for the source PSCell as the candidate cell through the bearer context modification procedure and the UE context modification procedure, and again configures the resource of the source PScell to the UE. In step 1022, the RRC Reconfiguration message carries the resource configuration information and the evaluation condition measurement configuration of the source PSCell. The RRC Reconfiguration message may also carry at least one indication of:
for example, a conditional RRC reconfiguration kept indication (condRRCReconfigKeptIndicatior=“true”). This indication may indicate based on the UE or based on the source PSCell. It is used to control the behaviors of the UE, that is, after the UE performs CPC once, the resource of the unselected source PSCell continue to be kept as the preparation for the next CPC. Only when being selected by the UE and used once, after the UE performs the next CPC and accesses other PSCells, the resource of the source PSCell will be released. It can be understood that, the resource of the source PSCell is kept if not used and will be released after being selected and used once.

In steps 1024 and 1025, for the next round of CPC, the UE continues to measure and evaluate all candidate PSCells including the unselected candidate PSCells in the last CPC and the source PSCell (configured through steps 1016 to 1023). In the following procedure, for each CPC, it may proceed to step 1008 and start looping.

In step 1026, for the next round of CPC, the MN transmits an Xn-U address indication to the source SN, where the indication carries information such as a CPC trigger indication and a data forwarding address. The source SN may perform the process of an early data forwarding.

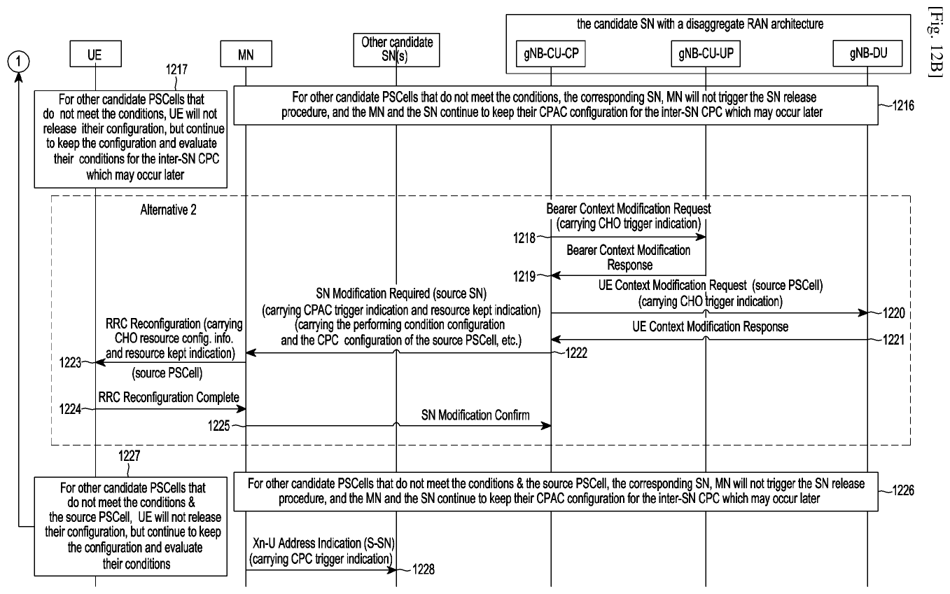

FIG. 11A, FIG. 11B, and FIG. 11C illustrate a diagram of a UE performing enhanced CPC initiated by a MN Inter-SN in accordance with various embodiments of the present disclosure, wherein FIG. 11A, FIG. 11B, and FIG. 11C illustrate alternative 3 and alternative 4.

In alternative 3, after performing CPC once, the resources of the source PSCell and all the candidate PSCells are kept at the network side and the UE side all the time. That is, after the UE performs CPC once and accesses to a certain candidate PSCell, the source PSCell is then used as the candidate PSCell for the next CPC. Regarding the configuration occasion of the source PSCell, in this solution, it is configured after the UE performs the first CPC.

In alternative 4, after performing CPC once, the resources of the source PSCell and all the candidate PSCells are kept at the network side and the UE side all the time. That is, after the UE performs CPC once and accesses to a certain candidate PSCell, the source PSCell is then used as the candidate PSCell for the next CPC. Regarding the configuration occasion of the source PSCell, in this solution, the source PSCell and the candidate PSCells are configured together when the CPC is initially configured.

Referring to FIG. 11A, FIG. 11B, and FIG. 11C, in step 1100, the UE performs NR measurement configuration and transmits the measurement report to the MN.

In step 1101, the MN decides to perform enhanced CPAC (CPA and/or CPC). That is, after the UE performs CPC once, the resources of the unselected candidate PSCells and the source PSCell will not be released immediately (except for special cases, the network side initiates a release request or decision for a corresponding candidate PSCell due to some other reasons) but continue to be kept as the candidate PSCells for the next CPC. That is, the resources of the candidate PSCells and the source PSCell are kept at the network side (gNB-CU and gNB-DU, or gNB-CU-CP, gNB-CU-UP and gNB-DU) all the time.

In step 1102, the MN transmits a SN Addition Request message to the candidate SNs. The MN initiates the SN addition request procedure, and for each candidate SN corresponding to all or part of the candidate PSCells provided in the UE measurement report, prepares the resources of the candidate PSCells for the UE. The SN Addition Request message may carry at least one indication of:
for example, CHO resource or context kept indication (CHO resource/context Kept Indicator=“true”). This indication indicates based on the candidate PSCell or based on the UE. It is used to control the behaviors of the candidate SN, that is, after the UE performs CPC once, the resources of the unselected candidate PSCells continue to be kept as the candidate PSCells of the next CPC. Even if the resource of a candidate PSCell is selected and utilized by the UE, after the UE performs the next CPC and accesses to other candidate PSCells, the resource of the candidate PSCell is still kept, that is, the source PSCell is used as the candidate PSCell for the next CPC. It can be understood that, the resources of the candidate PSCells and the source PSCell are kept at the SN side all the time.

If the candidate SN is a disaggregate architecture of CU-CP, CU-UP and gNB-DU, the gNB-CU-CP of the SN initiates a bearer context setup procedure, referring to step 903 in FIG. 9A. The Bearer Context Setup Request message may carry one indication of:
for example, CHO resource or context kept indication (CHO resource/context Kept Indicator=“true”). This indication indicates based on the UE. It is used to control the behaviors of the gNB-CU-UP of the candidate SN, that is, after the UE performs CPC once, continues to keep the resources as the preparation for the next CPC. That is, the resources of the candidate PSCells and the source PSCell are kept at the gNB-CU-UP of the SN side all the time.

Similarly, the gNB-CU-CP of the candidate SN and the belonging gNB-DU perform resource configuration for each candidate PSCell to which it belongs through the UE context setup procedure, referring to step 905 in FIG. 9A. The UE Context Setup Request message may carry at least one indication of:
for example, CHO resource or context kept indication (CHO resource/context Kept Indicator=“true”). This indication indicates based on the candidate PSCells. It is used to control the behaviors of the DU, that is, after the UE performs CPC once, the resources of the unselected candidate PSCells continue to be kept as the candidate PSCells of the next CPC. Even if the resource of a candidate PSCell is selected and utilized by the UE, after the UE performs the next CPC and accesses to other candidate PSCells, the resource of the candidate PSCell is still kept, that is, the source PSCell is used as the candidate PSCell for the next CPC. That is, the resources of the candidate PSCells and the source PSCell are kept at the gNB-DU and gNB-CU-CP of the SN side all the time.

In step 1103, after the SN has prepared the resources of the candidate PSCells, in response to the SN Addition Request, the SN transmits the SN Addition Request Acknowledge to the MN, and carries the resources of the relevant candidate PSCells.

In step 1104, after the UE performs CPC once, the resource of the source PSCell will be released by the UE and the network side in the current mechanism. If the source PSCell needs to be used as the candidate cell for the next CPC, the MN initiates a SN modification request procedure to the source SN, which triggers the source SN to modify the resource of the source PSCell as the candidate PSCell for the next CPC. The SN Modification Request message may carry at least one indication of:
for example, CHO resource or context kept indication (CHO resource/context Kept Indicator=“true”). This indication indicates based on the source PSCell. It is used to control the behaviors of the SN, that is, after the UE performs CPC once, the resource of the source PSCell continues to be kept as the candidate PSCell of the next CPC. That is, the resource of the source PSCell is kept at the SN side all the time.

If the candidate SN is a disaggregate architecture of CU-CP, CU-UP and gNB-DU, the gNB-CU-CP of the SN initiates a bearer context modification procedure to the gNB-CU-UP. In step 1105, the gNB-CU-CP of the SN transmits a Bearer Context Modification Request message to the gNB-CU-UP, and in step 1106, the gNB-CU-UP of the SN transmits a Bearer Context Modification Response message to the gNB-CU-CP. The Bearer Context Modification Request message may carry one indication of:
for example, CHO resource or context kept indication (CHO resource/context Kept Indicator=“true”). This indication indicates based on the UE. It is used to control the behaviors of the gNB-CU-UP of the source SN, that is, after the UE performs CPC once, continues to keep the resource as the preparation for the next CPC. That is, the resource of the source PSCell is kept at the gNB-CU-UP of the SN side all the time.

In step 1107, the gNB-CU-CP of the SN transmits a UE Context Modification Request message to the gNB-DU, and in step 1108, the gNB-DU of the SN transmits a UE Context Modification Response message to the gNB-CU-CP. The gNB-CU-CP of the source SN and the belonging gNB-DU perform resource modification for the source PSCell through the UE context modification procedure. The UE Context Modification Request message may carry at least one indication of:
for example, CHO resource or context kept indication (CHO resource/context Kept Indicator=“true”). This indication indicates based on the source PSCell. It is used to control the behaviors of the DU, that is, after the UE performs CPC once, the resource of the source PSCell continues to be kept as the candidate PSCell of the next CPC. That is, the resource of t the source PSCell is kept at the gNB-DU and gNB-CU-CP of the SN side all the time.

In step 1109, after the source SN prepares to modify the resource of the source PSCell, in response to the SN Modification Request, the source SN transmits a SN Modification Request Acknowledge message to the MN, which carries the resource of the source PSCell.

In step 1110, the MN transmits an Xn-U address indication to the source SN, where the indication carries information such as a CPC trigger indication and a data forwarding address. The source SN may perform the process of an early data forwarding.

In step 1111, the MN transmits the RRC Reconfiguration message to the UE. The gNB-CU of the source SN and the candidate SN configures the UE through the MN, wherein the RRC Reconfiguration message carries the resource configuration information and the evaluation condition measurement configuration (determined by the MN) of each candidate PSCell and the source PSCell (the PSCell currently serving the UE). The RRC Reconfiguration message may also carry at least one indication of:
for example, a conditional RRC reconfiguration kept indication (condRRCReconfigKeptIndicatior=“true”). This indication may indicate based on the UE or based on the candidate PSCells and the source PSCell. It is used to control the behaviors of the UE, that is, after the UE performs CPC once, it continues to keep the resources of the unselected candidate PSCells and the source PSCell as the candidate PSCells of the next CPC. That is, the resources and the evaluation condition measurement configuration of the candidate PSCells and the source PSCell are kept at the UE side all the time, unless the network side initiates the release.

In step 1112, after obtaining and storing the resources, the UE transmits an RRC Reconfiguration Complete message to the MN.

In steps 1113 and 1114, the UE measures and evaluates each candidate PSCell. When a certain PSCell meets the evaluation conditions, the UE transmits the RRC Reconfiguration Complete message to notify the MN, and then starts to access the target PSCell and applies the corresponding configuration.

In steps 1115 and 1116, when a certain PSCell meets the evaluation conditions, the UE transmits an RRC Reconfiguration Complete message to the MN, and the MN transmits a SN Reconfiguration Complete message to the selected target SN. Since the MN decides to perform enhanced CPAC, that is, after the UE performs CPC once, the resources of the unselected candidate PSCells and the source PSCell will not be released immediately (except for special cases, the network side initiates a release request or decision for a corresponding candidate PSCell due to some other reasons) but continue to be kept as the candidate PSCells for the next CPC. That is, the resources of the candidate PSCells and the source PSCell are kept at the network side (gNB-CU and gNB-DU, or gNB-CU-CP, gNB-CU-UP and gNB-DU) all the time.

In step 1117, the MN transmits an Xn-U address indication to the source SN, where the indication carries information such as a CPC trigger indication and a data forwarding address. The source SN may perform the process of late data forwarding.

In step 1118, the UE successfully accesses the target PSCell and utilizes the correfiguration kept indication when being configurated in step 1111, the UE performs the behavior of continuing to keep the resources and the evaluation condition measurement configuration of other unselected candidate PSCells and the source PSCell.

In step 1119, the MN may transmit the transport network layer address and tunnel endpoint ID information regarding to the reception of downlink data to the 5GC.

In steps 1120 to 1127 (for alternative 3), if the source PSCell and the candidate PSCells are not pre-configured together in steps 1104 to 1112, the configuration for the source PSCell can be considered after the UE performs CPC for the first time. Therefore, after the UE successfully accesses the target PSCell, the MN initiates a SN modification request process to the source SN, which triggers the source SN to modify the resource of the source PSCell as a candidate PSCell for the next CPC. Steps 1120 to 1125 correspond to the processes of steps 1104 to 1109 one-to-one. After the source SN completes the modification of the source PSCell resource, in step 1126, configures the UE through the RRC Reconfiguration message carrying the resource configuration information and the evaluation condition measurement configuration of the source PSCell. The RRC Reconfiguration message may also carry at least one indication of:
for example, a conditional RRC reconfiguration kept indication (condRRCReconfigKeptIndicatior=“true”). This indication may indicate based on the UE or based on the source PSCell. It is used to control the behaviors of the UE, that is, after the UE performs CPC once, the resource of the source PSCell continue to be kept as the candidate PSCell of the next CPC. Even if the resource of the source PSCell is selected and utilized by the UE again, it is still kept after the UE performs the next CPC and accesses other candidate PSCells. That is, the resource and the evaluation condition measurement configuration of the source PSCell are kept at the UE side all the time, unless the network side initiates the release.

In steps 1128 and 1129, at the network side, the MN and the candidate SNs continue to keep the resources of the candidate PSCells not selected by the UE and the source PSCell, and the UE side continues to keep the resources and the evaluation condition measurement configuration of other unselected candidate PSCells and source PSCell, as the preparation for the next CPC.

In step 1130, for the next round of CPC, the MN transmits an Xn-U address indication to the source SN, where the indication carries information such as a CPC trigger indication and a data forwarding address. The source SN may perform the process of an early data forwarding.

In step 1131, for the next round of CPC, the UE continues to measure and evaluate all the candidate PSCells, including the unselected candidate PSCells in the last CPC and the source PSCell.

In steps 1132 to 1138, for each CPC, similar processes are performed on both the UE side and the network side. After UE evaluates the conditions, selects a target PSCell meeting the conditions and successfully accesses the target PSCell, other candidate PSCells and the source PSCell serve as the candidate cells for the next CPC, and the UE side and the network side keep the resources all the time (unless for special cases, the network side (the gNB-DU or the gNB-CU) initiates a release request or decision for a corresponding candidate PSCell due to some other reasons). Then, the procedure may proceed to step 1131 and start looping.

In step 1139, for the next round of CPC, the MN transmits an Xn-U address indication to the source SN, where the indication carries information such as a CPC trigger indication and a data forwarding address. The source SN may perform the process of an early data forwarding.

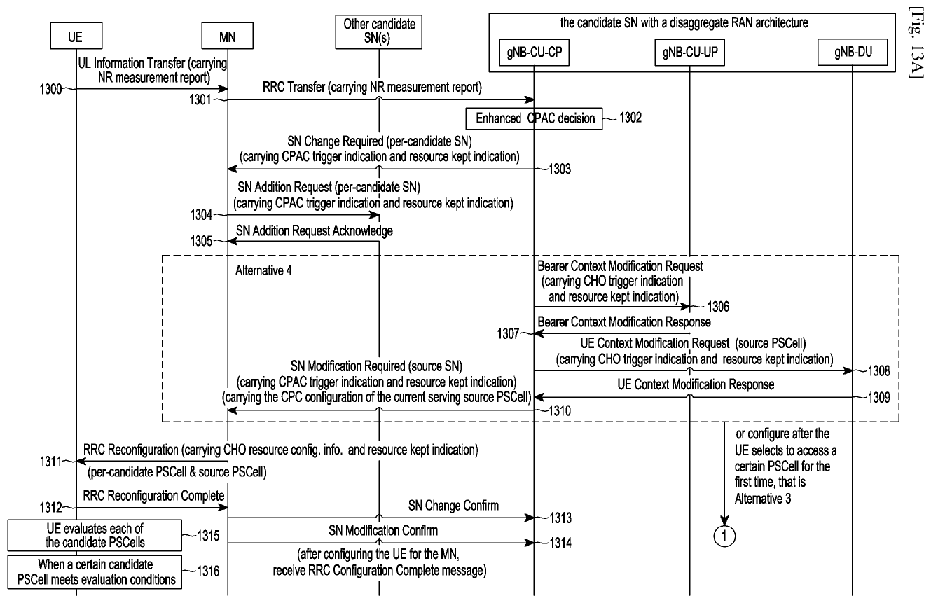

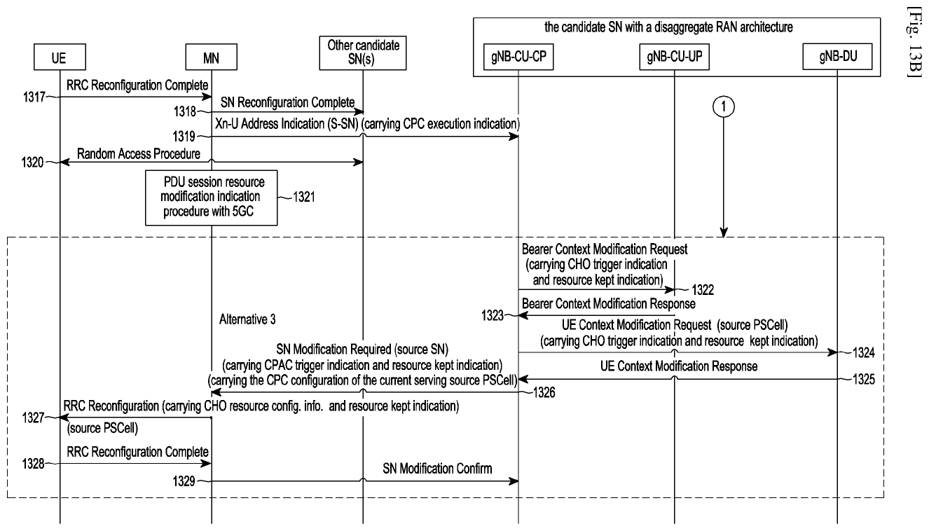

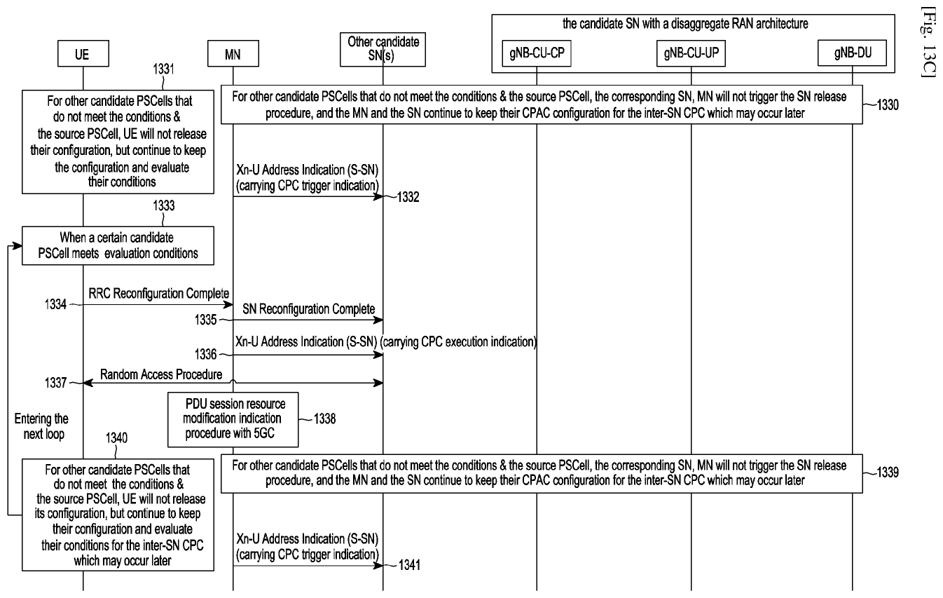

FIG. 12A and FIG. 12B illustrate a diagram of a UE performing enhanced CPC initiated by a SN Inter-SN in accordance with various embodiments of the present disclosure, wherein FIG. 12A and FIG. 12B illustrate alternative 1 and alternative 2.

In alternative 1, after the UE performs CPC once, the network side and the UE side release the resource of the source PSCell, which will no longer be used as the candidate PSCell for the next CPC. The resources of other unselected candidate PSCells are kept at the network side and the UE side, and the unselected candidate PSCells will be used as candidate PSCells for the next CPC. Only the resource of a candidate PSCell which is selected by the UE and used once will be released after the UE performs the next CPC and accesses other PSCells.

In alternative 2, after the UE performs CPC once, the resource of the source PSCell is configured at the network side and the UE side through signalling, and the source PSCell will be used as the candidate PSCell for the next CPC. The resources of other unselected candidate PSCells are kept at the network side and the UE side, and the unselected candidate PSCells will be used as candidate PSCells for the next CPC. Only the resource of a candidate PSCell which is selected by the UE and used once will be released after the UE performs the next CPC and accesses other PSCells.

Referring to FIG. 12A and FIG. 12B, in step 1200, the UE transmits an NR measurement report to the MN. In step 1201, the MN forwards the NR measurement report to the gNB-CU-CP or the gNB-CU of the SN.

In step 1202, the SN makes the decision of performing enhanced CPAC (CPA and/or CPC). That is, after the UE performs CPC once, the resources of the unselected candidate PSCells will not be released immediately due to not being selected (except for special cases, the network side initiates a release request or decision for a corresponding candidate PSCell due to some other reasons) but continue to be kept as the preparation for the next CPC. Only when being selected by the UE and used once, the resource of a candidate PSCell will be release after the UE performs the next CPC and accesses other PSCells. It can be understood that, the resources of the candidate PSCells are kept if not used and will be released after being selected and used once.

In step 1203, the SN transmit a SN Change Required message to the MN. The SN initiates the SN change required procedure, and for each candidate SN corresponding to all or part of the candidate PSCells provided in the UE measurement report, requests the MN to prepare the resources of the candidate PSCells for the UE, and carries the CPAC trigger indication information. The SN Change Required message may carry at least one indication of:
for example, CHO resource or context kept indication (CHO resource/context Kept Indicator=“true”). This indication indicates based on the candidate PSCell or based on the UE. It is used to control the behaviors of the MN, that is, after the UE performs CPC once, the resources of the unselected candidate PSCells continue to be kept as the candidate PSCells of the next CPC. Only when being selected by the UE and used once, the resource of a candidate PSCell will be release after the UE performs the next CPC and accesses the other PSCells. It can be understood that, the resources of the candidate PSCells are kept if not used and will be released after being selected and used once.

In step 1204, the MN transmits a SN Addition Request message to the candidate SNs. The MN initiates the SN addition request procedure to the corresponding candidate SN, prepares the resources of the candidate PSCells for the UE, and carries the CPAC trigger indication information.

In step 1205, after the SN has prepared the resources of the candidate PSCells, in response to the SN Addition Request message, the candidate SN transmits an SN Addition Request Acknowledge message to the MN, and carries the resource configuration of the relevant candidate PSCells.

In step 1206, the MN transmits the RRC Reconfiguration message to the UE. The SN configures the UE through the MN, wherein the RRC Reconfiguration message carries the resource configuration information and the evaluation condition measurement configuration (determined by the source SN) of each candidate PSCell. The RRC Reconfiguration message may also carry at least one indication of:
for example, a conditional RRC reconfiguration kept indication (condRRCReconfigKeptIndicatior=“true”). This indication may indicate based on the UE or based on the candidate PSCells. It is used to control the behaviors of the UE, that is, after the UE performs CPC once, it continues to keep the resources of the unselected candidate PSCells as the candidate PSCells of the next CPC. Only when being selected by the UE and used once, after the UE performs the next CPC and accesses the other PSCells, the resource of the candidate PSCell will be released. It can be understood that, the resources of the candidate PSCells are kept if not used and will be released after being selected and used once. Otherwise, the resources of the candidate PSCells are kept at the UE side all the time, unless the network side initiates the release.

In step 1207, after obtaining and storing the resources, the UE transmits an RRC Reconfiguration Complete message to the MN.

In step 1208, the MN informs the source SN of the completion of the CPC configuration complete and the data forwarding address by transmitting a SN Change Confirm message to the source SN. The source SN may perform the process of an early data forwarding.

In steps 1209 and 1210, the UE measures and evaluates each candidate PSCell. When a certain PSCell meets the evaluation conditions, the UE transmits the RRC Reconfiguration Complete message to inform the MN, and then starts to access the target PSCell and utilize the corresponding resource.

In steps 1211 and 1212, when a certain PSCell meets the evaluation conditions, the UE transmits an RRC Reconfiguration Complete message to the MN, and the MN transmits a SN Reconfiguration Complete message to the selected target SN. Since the MN knows that the enhanced CPAC is being performed (via step 1203), that is, after the UE performs CPC once, the resources of the unselected candidate PSCells will not be released immediately due to not being selected (except for special cases, the network side initiates a release request or decision for a corresponding candidate PSCell due to some other reasons) but continue to be kept as the candidate PSCells for the next CPC. Only when being selected by the UE and used once, the resource of a candidate PSCell will be released after the UE performs the next CPC and accesses other PSCells. It can be understood that, the resources of the candidate PSCells are kept if not used and will be released after being selected and used once.

In step 1213, the MN transmits an Xn-U address indication to the source SN, where the indication carries information about CPC execution indication. The source SN may perform the process of a late data forwarding.

In step 1214, the UE successfully accesses the target PSCell and utilizes the corresponding resource. At this time, since the UE obtains the conditional RRC reconfiguration kept indication when being configurated in step 1206, the UE performs the behavior of continuing to keep the resource configuration and the evaluation condition measurement configuration of other unselected candidate PSCells.

In step 1215, the MN may transmit the transport network layer address and tunnel endpoint ID information regarding to the reception of downlink data to the 5GC.

In steps 1216 and 1217, at the network side, the MN and the candidate SNs continue to keep the resources of the candidate PSCells not selected by the UE, and the UE side continues to keep the resources and evaluation condition measurement configuration of other unselected candidate PSCells, as the candidate PSCells for the next CPC.

In steps 1218 to 1225 (for alternative 2), after the UE performs CPC once, the resource configured for the source PSCell is released at the UE side, and meanwhile, at the network side, after learning that the UE successfully accesses the target PSCell, the MN will also trigger the UE context release procedure to release the resource of the source PSCell later. Therefore, after the UE accesses the target PSCell, if the source PSCell needs to be used as a candidate cell for the next CPC, the source SN may prepare resource for the source PSCell as the candidate cell through the SN modification required procedure. If the source SN is a disaggregate architecture of CU-CP, CU-UP and gNB-DU, the source SN performs the resource establishment of the source PSCell as a candidate cell through the bearer context modification procedure and the UE context modification procedure. When the source SN has prepared the source PSCell as the resource of the candidate cell for the next CPC, it informs the MN through the SN modification required procedure, and then configures the resource of the source PSCell to the UE.

In step 1222, the SN transmits a SN Modification Required message to the MN. In order to make the source PSCell as the candidate cell for the next CPC, the SN initiates the SN modification required procedure. The SN Modification Required message carries the corresponding resource and evaluation condition of the source SN, and carries the CPAC trigger indication information. The SN Modification Required message may carry one indication of:
for example, CHO resource or context kept indication (CHO resource/context Kept Indicator=“true”). This indication indicates based on the source PSCell or based on the UE. It is used to control the behaviors of the MN, that is, after the UE performs CPC once, the resources of the unselected source PSCells continue to be kept as the candidate PSCells of the next CPC. Only when being selected by the UE and used once, the resource of a candidate PSCell will be release after the UE performs the next CPC and accesses other PSCells. It can be understood that, the resources of the candidate PSCells are kept if not used and will be released after being selected and used once.

In step 1223, the MN transmits the RRC Reconfiguration message to the SN. Wherein, the RRC Reconfiguration message carries the resource configuration information and the evaluation condition measurement configuration of the source PSCell. The RRC Reconfiguration message may also carry at least one indication of:
for example, a conditional RRC reconfiguration kept indication (condRRCReconfigKeptIndicatior=“true”). This indication may indicate based on the UE or based on the source PSCell. It is used to control the behaviors of the UE, that is, after the UE performs CPC once, the resource of the unselected source PSCell continue to be kept as the preparation for the next CPC. Only when being selected by the UE and used once, after the UE performs the next CPC and accesses other PSCells, the resource of the source PSCell will be released. It can be understood that, the resource of the source PSCell is kept if not used and will be released after being selected and used once.

In step 1224, the UE transmits an RRC Reconfiguration Complete message to the MN. In step 1225, the MN transmits a SN Modification Confirm message to the SN.

In steps 1226 and 1227, for the next round of CPC, the UE continues to measure and evaluate all candidate PSCells including the unselected candidate PSCells in the last CPC and the source PSCell (configured through steps 1218 to 1225). In the following procedure, for each CPC, the following procedure may proceed to step 1210 and start looping.

In step 1228, for the next round of CPC, the MN transmits an Xn-U address indication to the source SN, where the indication carries information about such as a CPC trigger indication and a data forwarding address.

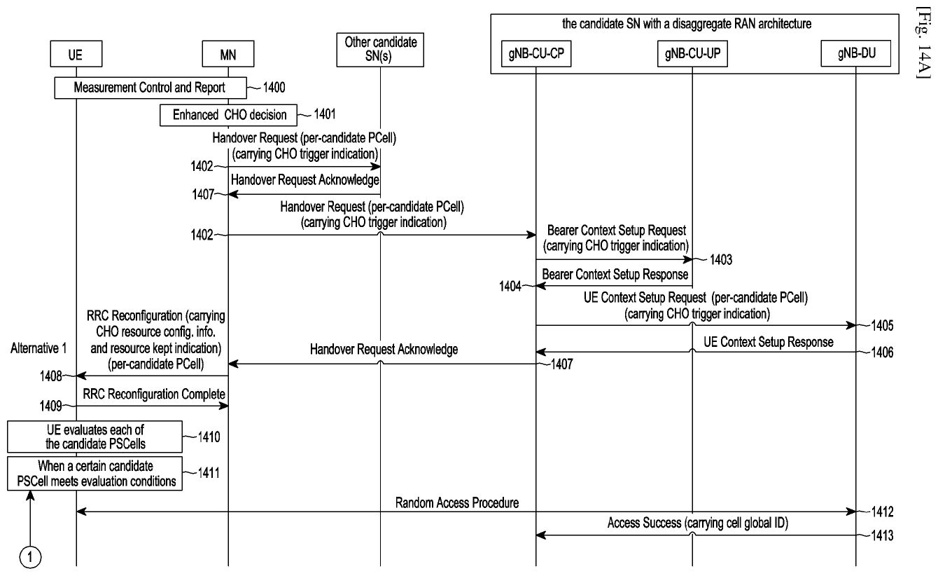

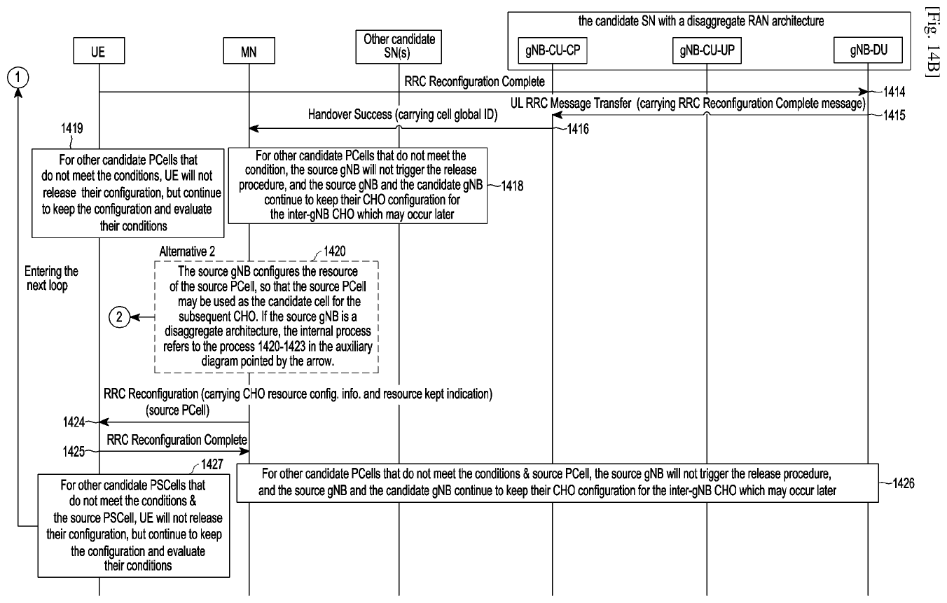

FIG. 13A, FIG. 13B, and FIG. 13C illustrate a diagram of a UE performing enhanced CPC initiated by a SN Inter-SN in accordance with various embodiments of the present disclosure, wherein FIG. 13A, FIG. 13B, and FIG. 13C illustrate alternative 3 and alternative 4.

In alternative 3, after performing CPC once, the resources of the source PSCell and all the candidate PSCells are kept at the network side and the UE side all the time. That is, after the UE performs CPC once and accesses a certain candidate PSCell, the source PSCell is then used as the candidate PSCell for the next CPC. Regarding the configuration occasion of the source PSCell, in this solution, it is configured after the UE performs the first CPC.

In alternative 4, after performing CPC once, the resources of the source PSCell and all the candidate PSCells are kept at the network side and the UE side all the time. That is, after the UE performs CPC once and accesses a certain candidate PSCell, the source PSCell is then used as the candidate PSCell for the next CPC. Regarding the configuration occasion of the source PSCell, in this solution, the source PSCell and the candidate PSCells are configured together when the CPC is initially configured.

Referring to FIG. 13A, FIG. 13B, and FIG. 13C, in step 1300, the UE transmits an NR measurement report to the MN. In step 1301, the MN forwards the measurement report to the gNB-CU-CP or the gNB-CU of the SN.

In step 1302, the SN makes the decision of performing enhanced CPAC (CPA and/or CPC). That is, after the UE performs CPC once, the resources of the unselected candidate PSCells and the source PSCell will not be released immediately (except for special cases, the network side initiates a release request or decision for a corresponding candidate PSCell due to some other reasons) but continue to be kept as the candidate PSCells for the next CPC. That is, the resources of the candidate PSCells and the source PSCell are kept at the network side (gNB-CU and gNB-DU, or gNB-CU-CP, gNB-CU-UP and gNB-DU) all the time.

In step 1303, the SN transmits a SN Change Required message to the MN. The SN initiates the SN change required procedure, and for each candidate SN corresponding to all or part of the candidate PSCells provided in the UE measurement report, requests the MN to prepare the resources of the candidate PSCells for the UE, and carries the CPAC trigger indication information. The SN Change Required message may carry one indication of:
for example, CHO resource or context kept indication (CHO resource/context Kept Indicator=“true”). This indication indicates based on the candidate PSCell or based on the UE. It is used to control the behaviors of the MN, that is, after the UE performs CPC once, the resources of the unselected candidate PSCells continue to be kept as the candidate PSCells of the next CPC. Even if the resource of a candidate PSCell is selected and utilized by the UE, after the UE performs the next CPC and accesses to other candidate PSCells, the resource of the candidate PSCell is still kept, that is, the source PSCell is used as the candidate PSCell for the next CPC. It can be understood that, the resources of the candidate PSCells and the source PSCell are kept at the MN side all the time.

In step 1304, the MN transmits a SN Addition Request message to the candidate SNs. The MN initiates the SN addition request procedure, prepares the resources of the candidate PSCells for the UE, and the SN Addition Request message may carry at least one indication of:
for example, CHO resource or context kept indication (CHO resource/context Kept Indicator=“true”). This indication indicates based on the candidate PSCell or based on the UE. It is used to control the behaviors of the candidate SN, that is, after the UE performs CPC once, the resources of the unselected candidate PSCells continue to be kept as the candidate PSCells of the next CPC. Even if the resource of a candidate PSCell is selected and utilized by the UE, after the UE performs the next CPC and accesses other candidate PSCells, the resource of the candidate PSCell is still kept, that is, the source PSCell is used as the candidate PSCell for the next CPC. It can be understood that, the resources of the candidate PSCells and the source PSCell are kept at the SN side all the time.

If the candidate SN is a disaggregate architecture of CU-CP, CU-UP and gNB-DU, the gNB-CU-CP of the SN initiates a bearer context setup procedure, referring to step 803 in FIG. 8A. The Bearer Context Setup Request message may carry one indication of:
for example, CHO resource or context kept indication (CHO resource/context Kept Indicator=“true”). This indication indicates based on the UE. It is used to control the behaviors of the gNB-CU-UP of the candidate SN, that is, after the UE performs CPC once, continues to keep the resource as the preparation for the next CPC. That is, the resources of the candidate PSCells and the source PSCell are kept at the gNB-CU-UP of the SN side all the time.

Similarly, the gNB-CU-CP of the candidate SN and the belonging gNB-DU perform resource configuration for each candidate PSCell to which it belongs through the UE context setup procedure, referring to step 805 in FIG. 8A. The UE Context Setup Request message may carry at least one indication of:
for example, CHO resource or context kept indication (CHO resource/context Kept Indicator=“true”). This indication indicates based on the candidate PSCells. It is used to control the behaviors of the DU, that is, after the UE performs CPC once, the resources of the unselected candidate PSCells continue to be kept as the candidate PSCells of the next CPC. Even if the resource of a candidate PSCell is selected and utilized by the UE, after the UE performs the next CPC and accesses other candidate PSCells, the resource of the candidate PSCell is still kept, that is, the source PSCell is used as the candidate PSCell for the next CPC. It can be understood that, the resources of the candidate PSCells and the source PSCell are kept at the gNB-DU and gNB-CU-CP of the SN side all the time.

In step 1305, after the SN has prepared the resources of the candidate PSCells, in response to the SN Addition Request message, the SN transmits the SN Addition Request Acknowledge message to the MN, and carries the resources of the relevant candidate PSCells.

After the UE performs CPC once, the resource of the source PSCell will be released by the UE and the network side in the current mechanism. If the source PSCell needs to be used as the candidate cell for the next CPC, the source SN modifies the resource of the source PSCell as the candidate PSCell for the next CPC. If the source SN is a disaggregate architecture of gNB-CU-CP, gNB-CU-UP and gNB-DU, the gNB-CU-CP of the source SN may initiate a bearer context modification procedure to the gNB-CU-UP. In step 1306, the gNB-CU-CP of the source SN transmits a Bearer Context Modification Request message to the gNB-CU-UP, and in step 1307, the gNB-CU-UP of the source SN transmits a Bearer Context Modification Response message to the gNB-CU-CP, wherein the Bearer Context Modification Request message may carry one indication of:
for example, CHO resource or context kept indication (CHO resource/context Kept Indicator=“true”). This indication indicates based on the UE. It is used to control the behaviors of the gNB-CU-UP of the source SN, that is, after the UE performs CPC once, continues to keep the resource as the preparation for the next CPC. That is, the resource of the source PSCell is kept at the gNB-CU-UP of the SN side all the time.

In step 1308, the gNB-CU-CP of the source SN transmits a UE Context Modification Request message to the gNB-DU to which the source PSCell belongs, and in step 1309, the belonging gNB-DU transmits a UE Context Modification Response message to the gNB-CU-CP of the source SN. The gNB-CU-CP of the source SN and the belonging gNB-DU perform resource modification for the source PSCell through the UE context modification procedure. The UE Context Modification Request message may carry at least one indication of:
for example, CHO resource or context kept indication (CHO resource/context Kept Indicator=“true”). This indication indicates based on the source PSCell. It is used to control the behaviors of the DU, that is, after the UE performs CPC once, the resource of the source PSCell continues to be kept as the candidate PSCell of the next CPC. That is, the resource of the source PSCell is kept at the gNB-DU and gNB-CU-CP of the SN side all the time.

In step 1310, the source SN transmits a SN Modification Required message to the MN. After the source SN completes the modification of the resource of the source PSCell, in order to make the source PSCell as the candidate cell for the next CPC, the source SN initiates the SN modification required procedure. The SN Modification Required message carries the corresponding resource and evaluation condition of the source PSCell, and carries the CPAC trigger indication information. The SN Modification Required message may carry one indication of:
for example, CHO resource or context kept indication (CHO resource/context Kept Indicator=“true”). This indication indicates based on the source PSCell or based on the UE. It is used to control the behaviors of the MN, that is, after the UE performs CPC once, the resource of the unselected source PSCell continues to be kept as the candidate PSCell of the next CPC. Even if being selected by the UE and used once, the resource of the source PSCell will be kept after the UE performs the next CPC and accesses other candidate PSCells, that is, the source PSCell is used as the candidate PSCell for the next CPC. It can be understood that, the resource of the source PSCell is kept at the MN side all the time.

In step 1311, the MN transmits the RRC Reconfiguration message to the UE. The gNB-CU of the source SN and the candidate SN configure the UE through the MN, wherein the RRC Reconfiguration message carries the resource configuration information and the evaluation condition measurement configuration (determined by the source SN) of each candidate PSCell and the source PSCell (the PSCell currently serving the UE). The RRC Reconfiguration message may also carry at least one indication of:
for example, a conditional RRC reconfiguration kept indication (condRRCReconfigKeptIndicatior=“true”). This indication may indicate based on the UE or based on the candidate PSCells and the source PSCell. It is used to control the behaviors of the UE, that is, after the UE performs CPC once, it continues to keep the resources of the unselected candidate PSCells and the source PSCell as the candidate PSCells of the next CPC. That is, the resources and the evaluation condition measurement configuration of the candidate PSCells and the source PSCell are kept at the UE side all the time, unless the network side initiates the release.

In step 1312, after obtaining and storing the configuration, the UE transmits an RRC Reconfiguration Complete message to the MN.

In step 1313, the MN informs the source SN of the completion of the CPC configuration complete and the data forwarding address by transmitting a SN Change Confirm message to the source SN. The source SN may perform the process of an early data forwarding.

In step 1314, resource configuration is performed to the source PSCell as a candidate cell for the next CPC, and it is reconfigured to the UE through RRC. After receiving the RRC Reconfiguration Complete message from the UE, the MN transmits a SN Modification Confirm message to the source SN.

In steps 1315 and 1316, the UE measures and evaluates each candidate PSCell. When a certain PSCell meets the evaluation conditions, the UE transmits the RRC Reconfiguration Complete message to inform the MN, and then starts to access the target PSCell and utilize the corresponding resource.

In steps 1317 and 1318, when a certain PSCell meets the evaluation condition, the UE transmits an RRC Reconfiguration Complete message to the MN, and the MN transmits a SN Reconfiguration Complete message to the selected target SN. Since the MN knows that the enhanced CPAC is being performed (via step 1303 and step 1310), that is, after the UE performs CPC once, the resources of the unselected candidate PSCells and the source PSCell will not be released immediately (except for special cases, the network side initiates a release request or decision for a corresponding candidate PSCell due to some other reasons) but continue to be kept as the candidate PSCells for the next CPC. That is, the resources of the candidate PSCells and the source PSCell are kept at the network side (gNB-CU and gNB-DU, or gNB-CU-CP, gNB-CU-UP and gNB-DU) all the time.

In step 1319, the MN transmits an Xn-U address indication to the source SN, where the indication carries information about CPC execution indication. The source SN may perform the process of a late data forwarding.

In step 1320, the UE successfully accesses the target PSCell and utilizes the correfiguration kept indication when being configurated in step 1311, the UE performs the behavior of continuing to keep the resources and the evaluation condition measurement configuration of other unselected candidate PSCells and the source PSCell.

In step 1321, the MN may transmit the transport network layer address and tunnel endpoint ID information regarding to the reception of downlink data to the 5GC.

In steps 1322 to 1329 (for alternative 3), this process is for the source PSCell being used as the candidate PSCell for the next CPC. If the source PSCell and candidate PSCells are not pre-configured together in steps 1306 to 1314, the configuration for the source PSCell can be considered after the UE performs CPC for the first time. Therefore, after the UE accesses the target PSCell, the source SN may prepare resource for the source PSCell as the candidate cell through the SN modification required procedure. If the source SN is a disaggregate architecture of CU-CP, CU-UP and gNB-DU, the source SN performs the resource configuration for the source PSCell as the candidate cell through the bearer context modification procedure and the UE context modification procedure. When the source SN completes the modification of the resource of the source PSCell, the resource and the evaluation condition configuration information of the source PSCell are transmitted to the MN through the SN modification required procedure, and then configured to the UE. Steps 1322 to 1326 correspond to the processes of steps 1306 to 1310 one-to-one. After the source SN completes the modification of the resource of the source PSCell, in step 1327, it configures the resource of the source PSCell to the UE through the RRC Reconfiguration message, wherein, the RRC Reconfiguration message carries the resource configuration information and the evaluation condition measurement configuration of the source PSCell. The RRC Reconfiguration message may also carry at least one indication of:
for example, a conditional RRC reconfiguration kept indication (condRRCReconfigKeptIndicatior=“true”). This indication may indicate based on the UE or based on the source PSCell. It is used to control the behaviors of the UE, that is, after the UE performs CPC once, the resource of the source PSCell continue to be kept as the candidate PSCell of the next CPC. Even if the resource of the source PSCell is selected and utilized by the UE again, it is still keep after the UE performs the next CPC and accesses other candidate PSCells. That is, the resource and the evaluation condition measurement configuration of the source PSCell are kept at the UE side all the time, unless the network side initiates the release.

In steps 1330 and 1331, at the network side, the MN and the candidate SNs continue to keep the resources of the candidate PSCells not selected by the UE and the source PSCell, and the UE side continues to keep the resources and the evaluation condition measurement configuration of other unselected candidate PSCells and source PSCell, as the preparation for the next CPC.

In step 1332, for the next round of CPC, the MN transmits an Xn-U address indication to the source SN, where the indication carries information about such as a CPC trigger indication and a data forwarding address. The source SN may perform the process of an early data forwarding.

In step 1333, for the next round of CPC, the UE continues to measure and evaluate all the candidate PSCells, including the unselected candidate PSCells in the last CPC and the source PSCell.

In steps 1334 to 1341, in the following process, for performing each CPC, similar processes are performed on both the UE side and the network side. After UE evaluates the conditions, and selects a target PSCell meeting the conditions and successfully accesses the target PSCell, other candidate PSCells and the source PSCell are used as the candidate cells for the next CPC, and the UE side and the network side keep the resources all the time (unless for special cases, the network side (the gNB-DU or the gNB-CU) initiates a release request or decision for a corresponding candidate PSCell due to some other reasons). Then, the procedure may proceed to step 1333 and start looping.

In step 1341, for the next round of CPC, the MN transmits an Xn-U address indication to the source SN, where the indication carries information about such as a CPC trigger indication and a data forwarding address. The source SN may perform the process of an early data forwarding.

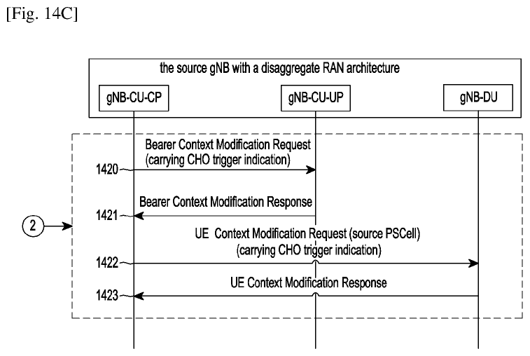

FIG. 14A, FIG. 14B, and FIG. 14C illustrate a diagram of a UE performing enhanced conditional handover (CHO) Intrer-gNB in accordance with various embodiments of the present disclosure, wherein FIG. 14A, FIG. 14B, and FIG. 14C illustrate alternative 1 and alternative 2.

In alternative 1, after the UE performs CHO once, the network side and the UE side release the resource of the source PCell, which will no longer be used as the candidate PCell for the next CHO. The resources of other unselected candidate PCells are kept at the network side and the UE side, and will be used as candidate PCells for the next CHO. Only the resource of a candidate PCell which is selected by the UE and used once will be released after the UE performs the next CHO and accesses the other PCells.

In alternative 2, after the UE performs CHO once, the resource of the source PCell are reconfigured at the network side and the UE side through signalling, and the source PCell will be used as the candidate PCell for the next CHO. The resources of other unselected candidate PCells are kept at the network side and the UE side, as candidate PCells for the next CPC. Only the resource of a candidate PCell which is selected by the UE and used once will be released after the UE performs the next CHO and accesses the other PCells.

Referring to FIG. 14A, FIG. 14B, and FIG. 14C, in step 1400, the UE performs NR measurement configuration and transmits the measurement report to the gNB.

In step 1401, the source gNB makes the decision of performing enhanced CHO. That is, after the UE performs CHO once, the resources of the unselected candidate PCells will not be released immediately (except for special cases, the network side initiates a release request or decision for a corresponding candidate PCell due to some other reasons) but continue to be kept as the candidate PCells for the next CHO. Only when being selected by the UE and used once, the resource of a candidate PCell will be release after the UE performs the next CHO and accesses other PCells. It can be understood that, the resources of the candidate PCells are kept if not used and will be released after being selected and used once.

In step 1402, the source gNB transmits a Handover Request message to the candidate gNBs. The source gNB initiates a handover request procedure, and for each candidate gNB corresponding to all or part of the candidate PCells provided in the UE measurement report, requests the candidate gNB to prepare the resources of the candidate PCells for the UE. The Handover Request message carries CHO trigger indication information.

If the candidate gNB is a disaggregate architecture of CU-CP, CU-UP and gNB-DU, in step 1403, the gNB-CU-CP of the candidate gNB transmits a Bearer Context Setup Request message to the gNB-CU-UP. The request carries CHO trigger indication information. In step 1404, the gNB-CU-UP of the candidate gNB transmits a Bearer Context Setup Response message to the gNB-CU-CP. In step 1405, the gNB-CU-CP of the candidate gNB transmits a UE Context Setup Request message to the gNB-DU to which the candidate PCell belongs, wherein the request carries CHO trigger indication information. In step 1406, the gNB-DU transmits a UE Context Setup Response message to the gNB-CU-CP of the candidate gNB. The gNB-CU-CP of the candidate gNB and the belonging gNB-DU perform resource configuration of the candidate PCell for each candidate PCell to which it belongs through the UE context setup procedure.

In step 1407, after the candidate gNB has prepared the resources of the candidate PCells, in response to the Handover Request message, the candidate gNB transmits a Handover Request Acknowledge message to the source gNB, and carries the resource configuration of the relevant candidate PCells.

In step 1408, after receiving the resource configuration of the candidate PCell, the source gNB configures the UE through an RRC Reconfiguration message, wherein the RRC Reconfiguration message carries the resource configuration information and the evaluation condition measurement configuration (determined by the source gNB) of each candidate PCell. The RRC Reconfiguration message may also carry at least one indication of:
a conditional RRC reconfiguration kept indication (condRRCReconfigKeptIndicatior=“true”). This indication may indicate based on the UE or based on the candidate PCell. It is used to control the behaviors of the UE, that is, after the UE performs CHO once, the resources of the unselected candidate PCells continue to be kept as the candidate PCells of the next CHO. Only when being selected by the UE and used once, after the UE performs the next CHO and accesses the other PCells, the resource of the candidate PCell will be released. It can be understood that, the resources of the candidate PCells are kept if not used and will be released after being selected and used once.

In step 1409, after obtaining and storing the resources, the UE transmits an RRC Reconfiguration Complete message to the gNB.

In steps 1410 and 1411, the UE measures and evaluates each candidate PCell. When a certain PCell meets the evaluation conditions, the UE starts to access the target PCell and utilize the corresponding configuration.

In steps 1412, the UE successfully accesses the target PCell and utilizes the corresponding resource. At this time, since the UE obtains the conditional RRC reconfiguration kept indication when being configurated through step 1408, the UE performs the behavior of continuing to keep the resources and the evaluation condition measurement configuration of other unselected candidate PCells.

After the UE successfully accesses the target PCell, in step 1413, the gNB-DU transmits the global ID of the candidate cell accessed by the UE to the gNB-CU-CP through the F1 Interface Access Success message. In step 1414, the UE transmits an RRC Reconfiguration Complete message to the gNB-DU. In step 1415, the target gNB-DU transmits an UL RRC Message Transfer carrying an RRC Reconfiguration Complete message to the target gNB-CU-CP.

In step 1416, when the condition of a certain PCell is met, the UE accesses successfully it and transmits an RRC Reconfiguration Complete message to the target gNB-CU-CP, and the target gNB transmits an Xn Interface Handover Success message to the source gNB and carries the global ID of the accessed candidate cell. Since the source gNB knows that the decision of the enhanced CHO is performed, that is, after the UE performs CHO once, the resources of the unselected candidate PCells will not be released immediately (except for special cases, the network side initiates a release request or decision for a corresponding candidate PCell due to some other reasons) but continue to be kept as the candidate PCells for the next CHO. Unless the network determines that it is necessary to release, increase, or update the resources of the candidate PCells according to the current situation.

In step 1417, the target gNB informs the 5GC to update the transport network layer address and tunnel endpoint ID information regarding to the reception of downlink data.

In steps 1418 and 1419, the network side continues to keep the resources of the candidate PCells not selected by the UE, and the UE side continues to keep the resources and the evaluation condition measurement configurations of other unselected candidate PCells, as preparations for the next CHO.

In steps 1420 to 1425 (for alternative 2), after the UE performs CHO once, the resource configured for the source PCell is released at the UE side, and meanwhile, at the network side, after learning that the UE successfully accesses the target PCell, the gNB will also trigger the release procedure to release the resource of the source PCell later. Therefore, after the UE accesses the target PCell, if the source PCell needs to be used as a candidate cell for the next CHO, the source gNB may prepare resource for the source PCell as the candidate cell through the modification procedure. If the source gNB is a disaggregate architecture of CU-CP, CU-UP and gNB-DU, the source gN-CU-CP performs the resource configuration for the source PCell as the candidate cell through the bearer context modification procedure and the UE context modification procedure (referring to steps 1420-1423), and configures to the UE again. In step 1424, the RRC Reconfiguration message carries the resource configuration information and the evaluation condition measurement configuration of the source PCell. The RRC Reconfiguration message may also carry one indication of:
for example, a conditional RRC reconfiguration kept indication (condRRCReconfigKeptIndicatior=“true”). This indication may indicate based on the UE or based on the source PCell. It is used to control the behaviors of the UE, that is, after the UE performs CHO once, the resources of the unselected source PCells continue to be kept as the preparation for the next CHO. Only when being selected by the UE and used once, after the UE performs the next CHO and accesses the other PCells, the resource of the PCell will be released. It can be understood that, the resource of the source PCell is kept if not used and will be released after being selected and used once.

In steps 1426 and 1427, for the next round of CHO, the UE continues to measure and evaluate all candidate PCells including the unselected candidate PCells in the last CHO and the source PCell (if configured through steps 1420 to 1425). In the following procedure, for each CHO, the following procedure may proceed to step 1411 and start looping.

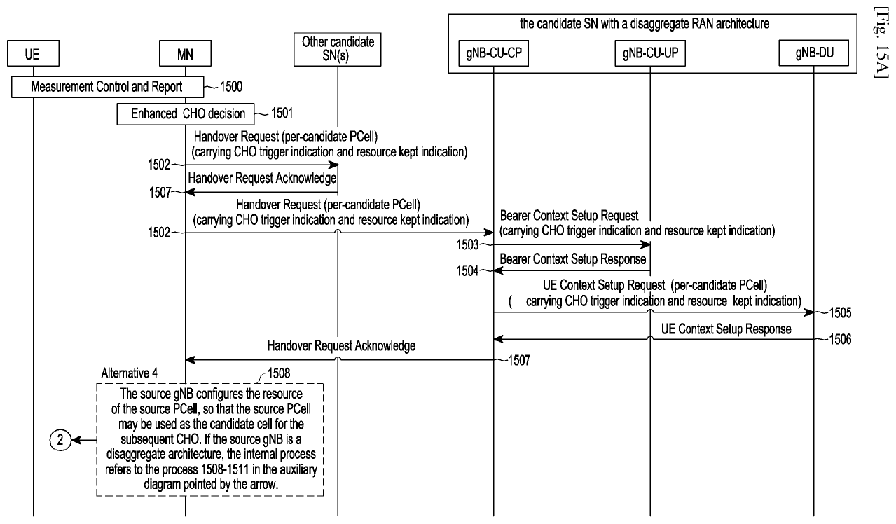

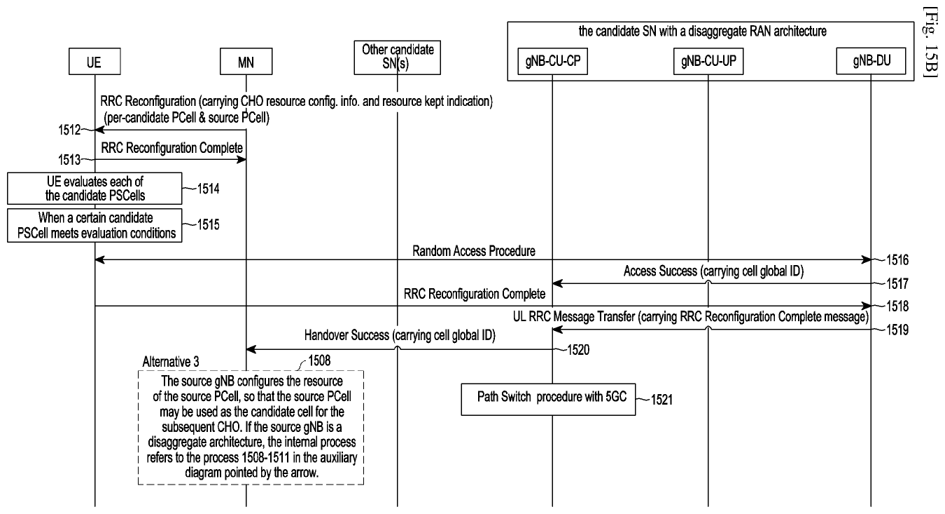

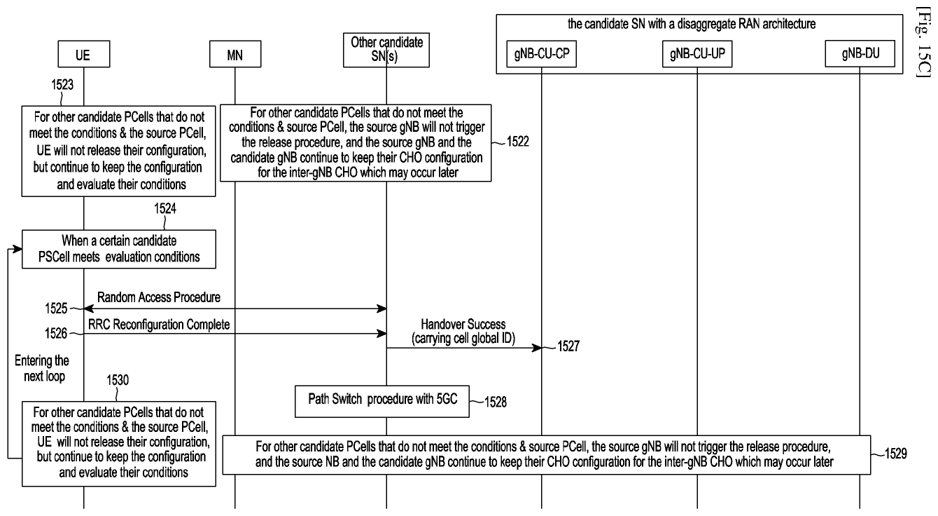

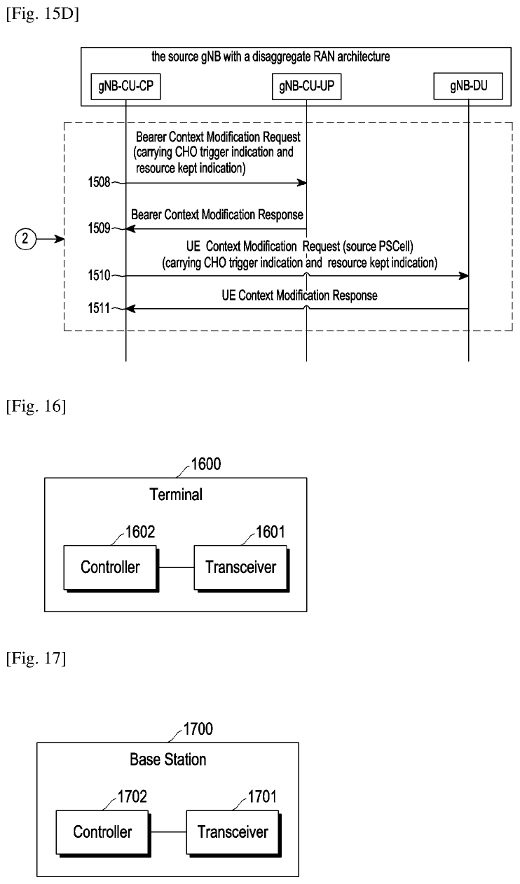

FIG. 15A, FIG. 15B, FIG. 15C, and FIG. 15D illustrate a diagram of a UE performing enhanced CHO between gNBs in accordance with various embodiments of the present disclosure, wherein FIG. 15A, FIG. 15B, FIG. 15C, and FIG. 15D illustrate alternative 3 and alternative 4.

In alternative 3, after performing CHO once, the resources of the source PCell and all the candidate PCells are kept at the network side and the UE side all the time. That is, after the UE performs CHO once and accesses to a certain candidate PCell, the source PCell is then used as the candidate PCell for the next CHO. Regarding the configuration occasion of the source PCell, in this solution, it is configured after the UE performs the first CHO.

In alternative 4, after performing CHO once, the resources of the source PCell and all the candidate PCells are kept at the network side and the UE side all the time. This is because, after the UE performs CHO once and accesses to a certain candidate PCell, the source PSCell is used as the candidate PCell for the next CHO. Regarding the configuration occasion of the source PCell, in this solution, the source PCell and the candidate PCells are configured together when the CHO is initially configured.

Referring to FIG. 15A, FIG. 15B, FIG. 15C, and FIG. 15D, in step 1500, the UE performs NR measurement configuration and transmits the measurement report to the gNB.

In step 1501, the source gNB makes the decision of performing enhanced CHO. That is, after the UE performs CHO once, the resources of the unselected candidate PCells and the source PCell will not be released immediately (except for special cases, the network side initiates a release request or decision for a corresponding candidate PCell due to some other reasons) but continue to be kept as the candidate PCells for the next CHO. That is, the resources of the candidate PCells and the source PCell continue to be kept at the network side (gNB-CU and gNB-DU, or gNB-CU-CP, gNB-CU-UP and gNB-DU), unless the network determines that it is necessary to release, increase, or update the resource of the candidate PCells according to the current situation.

In step 1502, the source gNB transmits a Handover Request message to the candidate gNBs. The source gNB initiates a handover request procedure, and for each candidate gNB corresponding to all or part of the candidate PCells provided in the UE measurement report, requests the candidate gNB to prepare the resources of the candidate PCells for the UE. The Handover Request message carries CHO trigger indication information, and may carry one or more indications of:
CHO resource or context kept indication (CHO resource/context Kept Indicator=“true”). This indication indicates based on the candidate PCell or based on the UE. It is used to control the behaviors of the candidate gNB, that is, after the UE performs CHO once, the resources of the unselected candidate PCells continue to be kept as the candidate PCells of the next CHO. Even if the resource of a candidate PCell is selected and utilized by the UE, after the UE performs the next CHO and accesses to other candidate PCells, the resource of the candidate PCell is still kept, that is, the source PCell is used as the candidate PCell for the next CHO. It can be understood that, the resources of the candidate PCells and the source PCell are kept at the candidate gNB side all the time.

If the candidate gNB is a disaggregate architecture of CU-CP, CU-UP and gNB-DU, in step 1503, the gNB-CU-CP of the candidate gNB transmits a Bearer Context Setup Request message to the gNB-CU-UP of the candidate gNB, and the Bearer Context Setup Request message carries the CHO trigger indication information and may carry one or more indications of:
for example, CHO resource or context kept indication (CHO resource/context Kept Indicator=“true”). This indication indicates based on the UE. It is used to control the behaviors of the gNB-CU-UP of the candidate gNB, that is, after the UE performs CHO onces, continues to keep the resources as the preparation for the next CHO. That is, the resources of the candidate PCells and the source PCell are kept at the gNB-CU-UP of the candidate gNB side all the time.

In step 1504, the gNB-CU-UP of the candidate gNB transmits a Bearer Context Setup Response message to the gNB-CU-CP of the candidate gNB.

In step 1505, the gNB-CU-CP of the candidate gNB transmits a UE Context SetupRequest message to the gNB-DU to which the candidate PCell belongs, wherein the UE Context Setup Request message carries CHO trigger indication information and one or more indications of:
for example, CHO resource or context kept indication (CHO resource/context Kept Indicator=“true”). This indication indicates based on the candidate PCells. It is used to control the opeartions of the DU, that is, after the UE performs CHO once, the resources of the unselected candidate PCells continue to be kept as the candidate PCells of the next CHO. Even if the resource of a candidate PCell is selected and utilized by the UE, after the UE performs the next CHO and accesses to other candidate PCells, the resource of the candidate PCell is still kept, that is, the source PCell is used as the candidate PCell for the next CHO. It can be understood that, the resources of the candidate PCells and the source PCell are kept at the gNB-DU and gNB-CU-CP of the candidate gNB side all the time.

In step 1506, gNB-DU transmits a UE Context Setup Response message to the gNB-CU-CP of the candidate gNB. The gNB-CU-CP of the candidate gNB and the gNB-DU perform resource configuration of the candidate PCell for each candidate PCell to which it belongs through the UE context setup procedure.

In step 1507, after the candidate gNB has prepared the resources of the candidate PCells, in response to the Handover Request message, the candidate gNB transmits a Handover Request Acknowledge message to the source gNB, and carries the resource configuration of the relevant candidate PCells.

After the UE performs CHO once, the resource of the source PCell will be released by the UE and the network side in the current mechanism. If the source PCell needs to be used as the candidate cell for the next CHO, the source gNB modifies the resource of the source PCell as the candidate PCell for the next CHO. If the source gNB is a disaggregate architecture of gNB-CU-CP, gNB-CU-UP and gNB-DU, in step 1508, the gNB-CU-CP of the source gNB transmits a Bearer Context Modification Request message to the gNB-CU-UP, wherein the Bearer Context Modification Request message carries CHO trigger indication information and one indication of:
for example, CHO resource or context kept indication (CHO resource/context Kept Indicator=“true”). This indication indicates based on the UE. It is used to control the behaviors of the gNB-CU-UP of the source gNB, that is, after the UE performs CHO once, the resource of the source PCell continues to be kept as the preparation for the next CHO. That is, the resource of the source PCell is kept at the gNB-CU-UP of the source gNB side all the time.

In step 1509, the gNB-CU-UP of the source gNB transmits a Bearer Context Modification Response message to the gNB-CU-CP of the source gNB.

In step 1510, the gNB-CU-CP of the source gNB transmits a UE Context Modification Request message to the gNB-DU to which the source gNB belongs. The UE Context Modification Request message carries CHO trigger indication information and one or more indications of:
CHO resource or context kept indication (CHO resource/context Kept Indicator=“true”). This indication indicates based on the source PCell. It is used to control the behaviors of the DU, that is, after the UE performs CHO once, the resource of the source PCell continues to be kept as the candidate PCell of the next CHO. That is, the resource configuration of the source PCell is kept at the gNB-DU and gNB-CU-CP of the source gNB side all the time.

In step 1511, the gNB-DU of the source gNB transmits a UE Context Modification Response message to the gNB-CU-CP of the source gNB.

In step 1512, when the source gNB completes modifying the resource of the source PCell and receives the resources of the candidate PCells, the UE is configured through an RRC Reconfiguration message carrying the resource configuration information and the evaluation condition measurement configuration (determined by the source gNB) of each candidate PCell and the source PCell. The RRC Reconfiguration message may also carry at least one indication of:
a conditional RRC reconfiguration kept indication (condRRCReconfigKeptIndicatior=“true”). This indication may indicate based on the UE or based on the candidate PCell and the source PCell. It is used to control the behaviors of the UE, that is, after the UE performs CHO once, the resources of the unselected candidate PCells and the source PCell continue to be kept as the candidate PCells of the next CHO. That is, the resources and the evaluation condition measurement configuration of the candidate PCells and the source PCell are kept at the UE side all the time, unless the network side initiates the release.

In step 1513, after obtaining and storing the resources, the UE transmits an RRC Reconfiguration Complete message to the gNB.

In steps 1514 and 1515, the UE measures and evaluates each candidate PCell. When a certain PCell meets the evaluation condition, the UE starts to access the target PCell and utilize the corresponding configuration.

In steps 1516, the UE successfully accesses the target PCell and utilizes the corresponding resource. At this time, since the UE obtains the conditional RRC reconfiguration kept indication when being configurated in step 1512, the UE performs the behavior of continuing to keep the resources and the evaluation condition measurement configuration of other unselected candidate PCells and the source PCell.

After the UE successfully accesses the target PCell, in step 1517, the gNB-DU of the target PCell transmits the global ID of the candidate cell accessed by the UE to the gNB-CU-CP of the target PCell through the F1 Interface Access Success message. In step 1518, the UE transmits an RRC Reconfiguration Complete message to the gNB-DU. In step 1419, the target gNB-DU transmits an UL RRC Message Transfer carrying an RRC Reconfiguration Complete message to the target gNB-CU-CP.

In step 1520, when the condition of a certain PCell is met, the UE accesses successfully it and transmits an RRC Reconfiguration Complete message to the target gNB-CU-CP, and the target gNB transmits an Xn Interface Handover Success message to the source gNB and carries the global ID of the accessed candidate cell. Since the source gNB knows that the decision of the enhanced CHO is performed, that is, after the UE performs CHO once, the resources of the unselected candidate PCells and the source PCell will not be released immediately (except for special cases, the network side initiates a release request or decision for a corresponding candidate PCell due to some other reasons) but continue to be kept as the candidate PCells for the next CHO. That is, the resources of the candidate PCells and the source PCell continue to be kept at the network side (gNB-CU and gNB-DU, or gNB-CU-CP, gNB-CU-UP and gNB-DU), unless the network determines that it is necessary to release, increase, or update the resource of the candidate PCells according to the current situation.

In step 1521, the target gNB informs the 5GC to update the transport network layer address and tunnel endpoint ID information regarding to the reception of downlink data.

For the source PCell as the candidate PCell for the next CHO, if the source PCell and the candidate PCells are not pre-configured together in steps 1508 to 1513, the configuration for the source PCell can be considered after the UE performs CHO for the first time. At this time, the source gNB performs the same steps 1508 to 1513, and modifies the resource of the source PCell so that it can be used as the candidate PCell for the next CHO.

In steps 1522 and 1523, the network side continues to keep the resources of the unselected candidate PCells and the source PCell, and the UE side continues to keep the resources and the evaluation condition measurement configuration of other unselected candidate PCells and source PCell, as the preparation for the next CHO.

In step 1524, for the next round of CHO, the UE continues to measure and evaluate all the candidate PCells, including the unselected candidate PCells in the last CHO and the source PCell.

In steps 1525 to 1530, for each CHO, similar processes are performed on both the UE side and the network side. After UE evaluates the conditions, selects a target PCell meeting the conditions and successfully accesses the target PCell, other candidate PCells and the source PCell are used as the candidate cells for the next CHO, and the UE side and the network side keep the resources all the time (unless for special cases, the network side (the gNB-DU or the gNB-CU) initiates a release request or decision for a corresponding candidate PCell due to some other reasons). Then, the procedure may proceed to step 1524 and start looping.

FIG. 16 illustrates a block diagram of a configuration of a terminal in accordance with various embodiments of the present disclosure.

Referring to FIG. 16, a terminal 1600 according to some embodiments of the present disclosure may include a transceiver 1601 and a controller 1602.

For example, the controller 1602 may be coupled to the transceiver 1601.

For example, the transceiver 1601 may be configured to transmit and receive signals.

For example, the controller 1602 may be configured to perform some of the behaviors (such as behaviors of a UE) according to some of the embodiments described above.

FIG. 17 illustrates a block diagram of a configuration of a base station in accordance with various embodiments of the present disclosure.

Referring to FIG. 17, a network node 1700 according to various embodiments of the present disclosure may include a transceiver 1701 and a controller 1702.

For example, the controller 1702 may be coupled to the transceiver 1701.

For example, the transceiver 1701 may be configured to transmit and receive signals.

For example, the controller 1702 may be configured to perform some of the behaviors (such as some of the behaviors of the RAN node, the NG-RAN node, the gNB-CU, or the gNB-DU) according to some of the embodiments described above.

In the above-mentioned embodiments, regarding to keeping the resources of the unselected candidate PSCells and the source PSCell as the candidate PSCells for the subsequent CPC process, if the following situations occur during or after the CPC and CPA process, it may need to update the resources of the candidate PSCells, including behaviors such as adding or releasing, because the current resource preparation may not be fully applicable to the next CPC process. The situations include:
After completing CPC or CPA once, the network side may selectively release the candidate PSCells according to the neighbour relationship configuration of the currently serving PSCell or the load status of the candidate PSCells, such as a candidate PSCell that do not have neighbour relationship with the currently serving PSCell, or a candidate PSCell whose service is overloaded, which needs to be released.
After completing CPC or CPA once, the network side may decide to add the resource of a new candidate PSCell or release the resource of an existing candidate PSCell according to the current UE measurement report.
After completing CPC or CPA once, if there is resource (such as PDU session/QoS flow/DRB) change, or bear type change during the execution, the network side may decide to update the configuration of the CPAC, for example, modifying the resources of the candidate PSCells through the interface procedure (which may relates to the Xn/F1/E1/NR-Uu interface), or directly releasing and then reconfiguring.

In the above-mentioned embodiments, evaluating and selecting from the candidate PSCells are based on the UE measurement. However, the present disclosure is not limited to this. During the process, the network side may directly configure the UE to access a certain target PSCell according to situations. It may carry one indication message to inform the UE (possibly through an RRC Reconfiguration message), which is used to indicate the UE to continue to keep the resources and the conditional measurement configuration of the candidate PSCells, or release the resources and conditional measurement configuration of the candidate PSCells.

In the above-mentioned embodiments, when the UE accesses to one of the candidate PSCells meeting the conditions after the evaluation and the measurement, if the source PSCell needs to be used as the candidate cell for the next CPC, the resource and condition measurement configuration of the source PSCell, together with the candidate PSCell, are configured to the UE by the network side when the CPA or the CPC is initially configured. Alternatively, after the UE performs the CPA or CPC for the first time, the resource and condition measurement configuration of the source PSCell may be configured to the UE, separately. Alternatively, the UE may also automatically change the resource configuration of the source PSCell to the configuration of the candidate cell of the subsequent CPC after accessing the target PSCell from the source PSCell.

In the above-mentioned embodiments, for the resources of the wireless access of the candidate PSCells, if the timer under control does not expire after being used, the resources continue to be valid. It may be considered to realize the kept of radio access resources on the network side and the UE side by the means of adjusting the timer.

In the above-mentioned embodiments, for when the network side and the UE side may automatically release the resources and the evaluation condition measurement configuration of the candidate PSCells, it can be determined according to one of the following situations:
the PCell in the MCG changes but the MN does not change. For example, the UE switches to another target cell under the same MN node.
the MN changes. For example, the UE switches to another target MN.

In the above embodiment, for the network side node, the gNB-CU-CP of the candidate SN indicates the UE-based or candidate PSCell-based resource kept indication information to the gNB-CU-UP or the gNB-DU. For whether to accept or reject the response of the gNB-CU-UP or the gNB-DU, explicit response information may be used to indicate the response based on the UE or the cell. Alternatively, as long as the gNB-CU-UP or the gNB-DU allocates resources, it means acceptance, and no explicit indication is required. Similarly, when relating to the Xn messages interacted between the MN and the SN, the above-mentioned principles may also be applied for indicating the response.

In the above-mentioned embodiments, regarding to the enhancement of CPA or CPC, both of them are the mechanisms for adding or changing the candidate PSCells in NR-DC. In practice, for the UE single connection scenario, the mechanism provided in the above embodiment is also applicable to the CHO scenario. For the Inter-gNB CHO scenario, referring to FIG. 14A, FIG. 14B, and FIG. 14C and FIG. 15A, FIG. 15B, FIG. 15C, and FIG. 15D, other applicable CHO scenarios are as follows:
For the Intra-DU CHO scenario, solutions similar to the solution described in FIG. 4B, and FIG. 4C and FIG. 5C, FIG. 5D, and FIG. 5E may also be applied, which relating to the enhancement for the F1 interface UE context modification procedure (referring to step 503 or 515 described in FIG. 5C) and the RRC reconfiguration procedure (referring to step 406 or 420 in FIG. 4B and FIG. 4C and step 506 or 518 in FIG. 5C). Similar enhancement is applied to behavior of the CU and DU at the network side and the UE.
For the Inter-DU Intra-CU CHO scenario, solutions similar to the solution described in FIG. 6A and FIG. 6B and FIG. 7A, FIG. 7B, and FIG. 7C may also be applied, which relating to the enhancement for the F1 interface UE context setup and UE context modification procedure (referring to step 703 or 717 described in FIG. 7A, FIG. 7B, and FIG. 7C) and the RRC reconfiguration procedure (referring to step 606 or 622 in FIG. 6A and FIG. 6B and step 706 or 720 in FIG. 7A, FIG. 7B, and FIG. 7C). Similar enhancement is applied to behavior of the CU and DU at the network side and the UE.

In the above-mentioned embodiments, between the gNB-CU and the gNB-DU, between the CU-CP and the CU-UP, and between the gNB and the UE, in the CHO, CPA, and CPC scenarios, for the indication message relating to the process enhancement that needs to be conveyed, such as CHO resource or context kept indications (CHO resource/context Kept Indicator=“true”) and conditional RRC reconfiguration kept indications (condRRCReconfigKeptIndicatior=“true”) may be explicitly expressed by explicit messages, or may be expressed implicitly. As long as the behavior of the network node and the UE are constrained and which is the same or similar behavior as mentioned in the embodiments of the present disclosure, these are all within the scope of the present invention.

In the above-mentioned embodiments, between the gNB-CU-CP and the gNB-DU, between the gNB-CU-CP and the gNB-CU-UP, and between the gNB and the UE, in the enhanced CHO, CPA, and CPC scenarios, when the UE performs CHO or CPAC once and completes the contention free-based random access to the target PCell or PSCell, in the current specification defines (referring to Section 5.1.6 specification TS38.321), the random access resource of the target cell previously configured through explicit signalling are discarded by the MAC entity. In this case, if the candidate PCell or PSCell accessed by UE, and if it needs to be used as a candidate cell in the subsequent CHO or CPAC (i.e., after performing one CHO or CPAC, the source PCell or source PSCell will be used as the candidate cells for the subsequent CHO or CPAC), the network side needs at least to prepare new random access resource, and then configure it to the UE. The affected process involves at least the F1 interface UE context modification request procedure and RRC reconfiguration procedure in the source gNB, or the Xn interface SN modification request procedure between the MN and the source SN, the F1 interface UE context modification request procedure in the source SN, and the RRC reconfiguration procedure of the MN.

In the above-mentioned embodiments, regarding to the resources of the candidate PCell or PSCell and the source PCell or PSCell, the solutions that the resources are kept on the network side and the UE side all the time (alternative 3 or alternative 4 of the embodiment). For resources of random access, when the DU of the candidate gNB receives the UE Context Modification/Setup Request message from the CU, since it carries the resource kept instruction based on the candidate cell, the DU prepares the random access resource of the corresponding candidate cell and performs the corresponding behaviors in the subsequent process. That is, after the UE switches and accesses to this cell and then switches out of this cell, the previously configured random access resource at the DU side (MAC entity) still kept. Similarly, for each candidate cell, during the RRC reconfiguration of the UE, since it carries the resource kept instruction based on the candidate cell, and thus the UE performs corresponding behaviors in the subsequent process according to the indications. That is, the UE uses this random access resource to switch and access to this cell and then switches out of this cell, the previously configured random access resource at the UE side (MAC entity) is still kept. Obviously, the solution that the resources of candidate cells are always kept on the network side and the UE side has an impact on the current specification (referring to Section 5.1.6 Specification TS38.321), and the specification needs to be further improved. For example, through a certain method, the MAC entity obtains the indication to keep the random access resource of the candidate cell from the upper layer, and then perform corresponding behaviors. That is, after the UE switches and accesses to this cell, and then switches out of this cell, the previously configured random access resource at the network side and the UE side (MAC entity) is still kept.

In the above-described embodiments, all behaviors and messages may be selectively performed or omitted. Additionally, the steps in each embodiment are not necessary to be performed sequentially and the order may vary. The information transfer may also be performed out of sequence, and the sequence of the information transfer may be changed.

Meanwhile, the exemplary embodiments of the present disclosure shown and described in the specification and the accompanying drawings correspond to specific examples presented for easily explaining the technical content of the present invention and to help the understanding of the present invention, and are not intended to limit the present invention scope of invention. That is, to those skilled in the art that, the realization of the modifications to the present invention based on the technical spirit of the present disclosure will be apparent.

1-15. (canceled)

16. A method performed by a user equipment (UE) in a wireless communication system, the method comprising:
receiving a message including a first indication, wherein the first indication indicates that candidate primary secondary cells (PSCells) for subsequent conditional PSCell addition or change (CPAC) are configured;
determining a target cell from the candidate PSCells; and
performing a cell access.

17. The method of claim 16, wherein the message includes a radio resource control (RRC) reconfiguration message.

18. The method of claim 16, further comprising:
keeping a configuration of the candidate PSCells after performing the cell access; and
evaluating conditions of the candidate PSCells.

19. A method performed by a network node in a wireless communication system, the method comprising:
transmitting, to a user equipment (UE), a first message including a first indication, wherein the first indication indicates that candidate primary secondary cells (PSCells) for subsequent conditional PSCell addition or change (CPAC) are configured; and
receiving, from the UE, a second message.

20. The method of claim 19, wherein the first message includes a radio resource control (RRC) reconfiguration message.

21. The method of claim 19, wherein the second message includes a radio resource control (RRC) configuration complete message.

22. A user equipment (UE), comprising:
a transceiver; and
a processor, coupled to the transceiver and configured to:
receive a message including a first indication, wherein the first indication indicates that candidate primary secondary cells (PSCells) for subsequent conditional PSCell addition or change (CPAC) are configured,
determine a target cell from the candidate PSCells, and
perform a cell access.

23. The UE of claim 22, wherein the message includes a radio resource control (RRC) reconfiguration message.

24. The UE of claim 22, further configured to:
keep a configuration of the candidate PSCells after performing the cell access, and
evaluate conditions of the candidate PSCells.

25. A network node, comprising:
a transceiver; and
a processor, coupled to the transceiver and configured to:
transmit, to a user equipment (UE), a first message including a first indication, wherein the first indication indicates that candidate primary secondary cells (PSCells) for subsequent conditional PSCell addition or change (CPAC) are configured, and
receive, from the UE, a second message.

26. The network node of claim 25, wherein the first message includes a radio resource control (RRC) reconfiguration message.

27. The network node of claim 25, wherein the second message includes a radio resource control (RRC) configuration complete message.
